(19) United States
(12) Patent Application Publication
(10) Pub. No.: US 2024/0080697 A1
(43) Pub. Date: Mar. 7, 2024

(54) MODIFYING MEASUREMENT REPORTING BEHAVIOUR AT A REMOTE WTRU BASED ON A LINK QUALITY INDICATION ASSOCIATED WITH A LINK BETWEEN A RELAY WTRU AND A NETWORK

(71) Applicant: IDAC HOLDINGS, INC., Wilmington, DE (US)

(72) Inventors: Oumer Teyeb, Montreal (CA); Martino M. Freda, Laval (CA); Jaya Rao, Montreal (CA); Tuong Duc Hoang, Montreal (CA)

(73) Assignee: InterDigital Patent Holdings, Inc., Wilmington, DE (US)

(21) Appl. No.: 18/271,711

(22) PCT Filed: Jan. 11, 2022
(86) PCT No.: PCT/US2022/011945

§ 371 Date: Jul. 11, 2023

Related U.S. Application Data
(60) Provisional application No. 63/136,154, filed on Jan. 11, 2021.

(51) Int. Cl. H04W 24/10; H04B 17/318; H04B 17/336

(52) U.S. Cl. CPC H04W 24/10; H04B 17/328; H04B 17/336

(57) ABSTRACT

Systems, methods, and instrumentalities are described herein associated with relay usage (e.g., new radio (NR) relays used as an example herein) where handovers between sidelink (SL) and direct link and/or between sidelinks may be based on consideration of end-to-end radio and/or load conditions. Handover decisions may be determined, for example, based on measurements of direct connections, sidelink connections, and/or backhaul connections. Handover decisions may be optimized, for example, based on measurement reporting behavior. A remote wireless transmit/receive unit (WTRU) (e.g., a WTRU that may be configured to connect to a network, for example, using a relay WTRU) in sidelink relay operation with a relay WTRU may determine measurement reporting behavior (e.g., associated with performed measurements of the direct connections, sideline connections, and/or backhaul connections), for example, while considering the sidelink quality associated with the relay WTRU.

### CROSS-REFERENCE TO RELATED APPLICATIONS

The application claims the benefit of U.S. Provisional Application 63/136,154, filed Jan. 11, 2021, the contents of which are incorporated by reference in their entirety herein.

### BACKGROUND

Mobile communications using wireless communication continue to evolve. A fifth generation of mobile communication radio access technology (RAT) may be referred to as 5G new radio (NR). A previous (legacy) generation of mobile communication RAT may be, for example, fourth generation (4G) long term evolution (LTE).

### SUMMARY

Systems, methods, and instrumentalities are described herein associated with relay usage (e.g., new radio (NR) relays used as an example herein) where handovers between sidelink (SL) and direct link and/or between sidelinks may be based on consideration of end-to-end radio and/or load conditions. Handover decisions may be determined, for example, based on measurements of direct connections, sidelink connections, and/or backhaul connections. Handover decisions may be optimized, for example, based on measurement reporting behavior. A remote wireless transmit/receive unit (WTRU) (e.g., a WTRU that may be configured to connect to a network, for example, using a relay WTRU) in sidelink relay operation with a relay WTRU may determine measurement reporting behavior (e.g., associated with performed measurements of the direct connections, sideline connections, and/or backhaul connections), for example, while considering the sidelink quality associated with the relay WTRU.

A remote WTRU may be configured to receive configuration information, e.g., from a network. The configuration information may include a set of measurement reporting conditions. Each measurement reporting condition in the set of the measurement reporting conditions may be or may be associated with a respective backhaul link quality (e.g., backhaul link quality value, range of backhaul link quality values). The measurement reporting conditions may be associated with a reference signal received power (RSRP) threshold, a reference signal received quality (RSRQ) threshold, a received signal to noise indicator (RSNI) threshold, and/or the like. The remote WTRU may be configured to receive a link quality indication (e.g., backhaul link quality indication), for example, from a relay WTRU. The link quality indication may be associated with a link between the relay WTRU and the network (e.g., a backhaul link). The remote WTRU may be configured to select a measurement reporting condition from the set of measurement reporting conditions, for example, based on the link quality indication and the respective backhaul link qualities (e.g., select the measurement reporting condition associated with its respective backhaul link quality that corresponds with the received link quality indication. The remote WTRU may be configured to obtain measurement(s) (e.g., perform measurement(s), receive measurement(s)). The measurement(s) may comprise measurement(s) of one or more of the sidelink radio link between the remote WTRU and the relay WTRU, a neighbor sidelink (e.g., a sidelink radio link between the remote WTRU and a second relay WTRU), a neighbor direct link (e.g., a radio link between the remote WTRU and the network via a different gNB), etc. The measurement(s) may be obtained, for example, based on measurement information indicated by the configuration information. The remote WTRU may be configured to determine if the measurement reporting condition is satisfied, for example, based on the obtained measurement(s). The WTRU may be configured to send a measurement report (e.g., the measurement(s)) to the network, for example, based on a determination that the measurement reporting condition is satisfied. The WTRU may be configured to change measurement reporting parameters, for example, based on a determination that the reporting condition is satisfied.

The link quality indication may be associated with a radio link measurement. For example, the link quality indication may be an offset value, a scaling value, and/or the link. The link quality indication may be an RSRP, an RSRQ, an RSNI, and/or the like. The link quality indication may be associated with load conditions, for example, the link quality indication may indicate a quality of the link between the second WTRU and the network.

The remote WTRU may be configured to receive configuration information, for example, indicating a measurement reporting condition. The remote WTRU may receive a link quality indication from a relay WTRU. The link quality indication may be associated with a link between the relay WTRU and the network. The remote WTRU may determine a scaled measurement reporting condition. For example, the scaled measurement reporting condition may be determined based on applying a scaling factor to the measurement reporting condition. The scaling factor may be associated with the link quality indication. The scaling factor may be obtained (e.g., received) from the relay WTRU, a neighbor WTRU, or the network. The scaling factor may be determined (e.g., by the remote WTRU), for example, based on the link quality indication. The remote WTRU may be configured to obtain measurement(s) (e.g., perform measurement(s), receive measurement(s)). The measurement(s) may comprise measurement(s) of one or more of the sidelink radio link between the remote WTRU and the relay WTRU, a neighbor sidelink (e.g., a sidelink radio link between the remote WTRU and a second relay WTRU), a neighbor direct link (e.g., a radio link between the remote WTRU and the network via a different gNB), etc. The remote WTRU may be configured to determine if the scaled measurement reporting condition is satisfied, for example, based on the obtained measurement(s). The remote WTRU may be configured to send a measurement report (e.g., the measurement(s)) to the network, for example, based on a determination that the scaled measurement reporting condition is satisfied. The WTRU may be configured to change measurement reporting parameters, for example, based on a determination that the scaled reporting condition is satisfied.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example of a user plane radio protocol stack for a layer 2 evolved WTRU-to-Network relay.

FIG. 3 illustrates an example of a control plane radio protocol stack for a layer 2 evolved WTRU-to-Network relay.

FIG. 4 illustrates an example of a user plane stack for an NR L2 WTRU-to-Network relay without an adaptation layer at PC5.

FIG. 5 illustrates an example a control plane protocol stack for an L2 WTRU-to-Network relay without an adaptation layer at PC5.

FIG. 6 illustrates an example of a user plane protocol stack for an L2 WTRU-to-Network relay with an adaptation layer supported at the PC5 interface.

FIG. 7 illustrates an example a control plane protocol stack for an L2 WTRU-to-Network relay with an adaptation layer supported at the PC5 interface.

FIG. 8 illustrates an example procedure for remote WTRU switching to a direct Uu cell.

FIG. 9 illustrates an example procedure for switching a remote WTRU to an indirect relay WTRU.

FIG. 10 illustrates an example of a procedure for establishing a remote WTRU connection.

FIG. 11 illustrates an example of a measurement model.

FIG. 12 illustrates an example of a relay WTRU used as a WTRU to WTRU relay.

FIG. 13 illustrates an example of a relay WTRU used as a WTRU-to-NW relay.

FIG. 14 illustrates an example of a remote WTRU sending measurement reports based on a backhaul link quality indication.

FIG. 15 illustrates an example of multiple relay WTRUs between a remote WTRU and a gNB.

### EXAMPLE NETWORKS FOR IMPLEMENTATION OF THE EMBODIMENTS

Systems, methods, and instrumentalities are described herein for new radio (NR) relays where handovers between sidelink and direct link and/or between sidelinks may be based on consideration of end-to-end radio and/or load conditions. Measurement configuration may be provided or received. Measurement reporting may be generated or received. A WTRU may be configured to modify measurement results of a sidelink radio, for example, based on the radio conditions on the backhaul link between the relay WTRU and the gNB. A WTRU may be configured to modify reporting behavior for sidelink radio measurements, for example, based on radio conditions on a backhaul link between the relay WTRU and the gNB. A WTRU may be configured to modify measurement results of a sidelink radio, for example, based on load conditions at the relay WTRU or the backhaul link between the relay WTRU and the gNB. A WTRU may be configured to modify the reporting behavior for sidelink radio measurements, for example, based on load conditions at the relay WTRU or the backhaul link between the relay WTRU and the gNB. A relay WTRU may be configured to provide information to a remote WTRU about radio/load conditions of a backhaul link between the relay WTRU and the gNB.

In examples, a WTRU may be configured to operate as a remote WTRU for connecting to a base station (e.g., a gNB) via a relay WTRU. The WTRU may receive (e.g., from the NW or the relay WTRU) a measurement configuration related to the sidelink. The WTRU may receive (e.g., from the NW or the relay WTRU) an indication about the link between the relay WTRU and the gNB (e.g., referred to as the backhaul link). The indication may include, for example, one or more of the following: the radio conditions between the relay WTRU and the gNB (e.g., radio measurements, such as RSRP, RSRQ, and/or RSNI, and/or an offset/scaling factor based on the measurements); and/or the load conditions between the relay WTRU and the gNB (e.g., a buffer status at the relay WTRU, or an offset and/or scaling factor based on the buffer status). A measurement configuration may include trigger conditions and/or events for reporting serving and/or neighbor sidelink and/or direct link radio conditions. Trigger conditions may include, for example, one or more of the following: sidelink and/or direct link RSRP, RSRQ, and/or RSNI thresholds; relative offsets between serving and neighbor sidelink and/or direct links; sidelink CBR and/or CR thresholds; priority of active sidelink RLC channels; UL pending data threshold; downlink data reception rate and/or volume threshold; and/or reporting periodicity. The WTRU may perform the serving/neighbor sidelink and/or direct link measurements. The WTRU may modify the sidelink measurements (e.g., depending on the received indication about the backhaul link), for example, in one or more of the following ways: scaling the sidelink measurement results up and/or down; replacing the sidelink measurements with a weighted average of the sidelink measurements and the received measurements of the backhaul; replacing the sidelink measurements with the weaker of the sidelink measurements and the received backhaul measurements; and/or replacing the sidelink measurements with the stronger of the sidelink measurements and the received backhaul measurements. The WTRU may use the modified sidelink measurements, for example, to determine whether the trigger conditions and/or events for reporting measurements are fulfilled. The WTRU may send the serving and/or neighbor sidelink and/or direct link radio measurements, for example, if/when the trigger conditions are fulfilled.

In examples, trigger conditions that depend on indications about the backhaul may be used in addition to (e.g., on top of) trigger conditions related to the access link (e.g., instead of modifying the access link measurements based on the indications about the backhaul). A WTRU may be configured to operate as a remote WTRU for connecting to a base station (e.g., a gNB) via a relay WTRU. The WTRU may receive (e.g., from the NW or the relay WTRU) a measurement configuration related to the sidelink. The WTRU may receive (e.g., from the NW or the relay WTRU) an indication about the link between the relay WTRU and the gNB (e.g., the backhaul link). The indication may include, for example, one or more of the following: the radio conditions between the relay WTRU and the gNB (e.g., radio measurements, such as RSRP, RSRQ, and/or RSNI, and/or an offset/scaling factor based on the measurements); and/or the load conditions between the relay WTRU and the gNB (e.g., a buffer status at the relay WTRU, or an offset and/or scaling factor based on the buffer status). The measurement configuration may include trigger conditions and/or thresholds related to the radio and load conditions of the backhaul link for reporting serving and/or neighbor sidelink and/or direct link radio conditions. The measurement configuration may include trigger conditions and/or thresholds for reporting serving and/or neighbor sidelink and/or direct link radio conditions related to the radio conditions of the access link. The access link may be, for example, a sidelink between the remote WTRU and the serving and/or candidate relay WTRU; or a direct link between the remote WTRU and the serving and/or candidate gNB. The WTRU may perform the serving and/or neighbor sidelink and/or direct link measurements. The WTRU may send the measurements results, for example, if/when the trigger conditions for the backhaul and/or the access links are fulfilled.

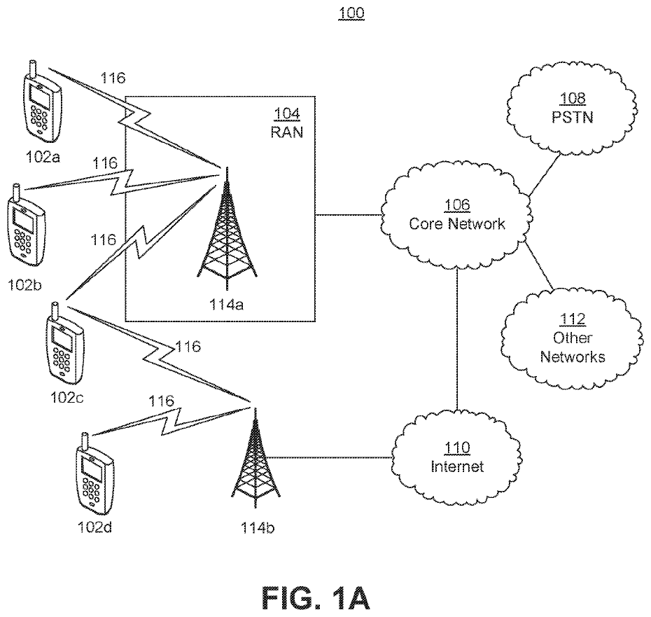

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (10), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Systems, methods, and instrumentalities are described herein associated with relay usage (e.g., new radio (NR) relays used as an example herein) where handovers between sidelink (SL) and direct link and/or between sidelinks may be based on consideration of end-to-end radio and/or load conditions. Handover decisions may be determined, for example, based on measurements of direct connections, sidelink connections, and/or backhaul connections. Handover decisions may be optimized, for example, based on measurement reporting behavior. A remote wireless transmit/receive unit (WTRU) (e.g., a WTRU that may be configured to connect to a network, for example, using a relay WTRU) in sidelink relay operation with a relay WTRU may determine measurement reporting behavior (e.g., associated with performed measurements of the direct connections, sideline connections, and/or backhaul connections), for example, while considering the sidelink quality associated with the relay WTRU.

A remote WTRU may be configured to receive configuration information, e.g., from a network. The configuration information may include a set of measurement reporting conditions. Each measurement reporting condition in the set of the measurement reporting conditions may be or may be associated with a respective backhaul link quality (e.g., backhaul link quality value, range of backhaul link quality values). The measurement reporting conditions may be associated with a reference signal received power (RSRP) threshold, a reference signal received quality (RSRQ) threshold, a received signal to noise indicator (RSNI) threshold, and/or the like. The remote WTRU may be configured to receive a link quality indication (e.g., backhaul link quality indication), for example, from a relay WTRU. The link quality indication may be associated with a link between the relay WTRU and the network (e.g., a backhaul link). The remote WTRU may be configured to select a measurement reporting condition from the set of measurement reporting conditions, for example, based on the link quality indication and the respective backhaul link qualities (e.g., select the measurement reporting condition associated with its respective backhaul link quality that corresponds with the received link quality indication. The remote WTRU may be configured to obtain measurement(s) (e.g., perform measurement(s), receive measurement(s)). The measurement(s) may comprise measurement(s) of one or more of the sidelink radio link between the remote WTRU and the relay WTRU, a neighbor sidelink (e.g., a sidelink radio link between the remote WTRU and a second relay WTRU), a neighbor direct link (e.g., a radio link between the remote WTRU and the network via a different gNB), etc. The measurement(s) may be obtained, for example, based on measurement information indicated by the configuration information. The remote WTRU may be configured to determine if the measurement reporting condition is satisfied, for example, based on the obtained measurement(s). The WTRU may be configured to send a measurement report (e.g., the measurement(s)) to the network, for example, based on a determination that the measurement reporting condition is satisfied. The WTRU may be configured to change measurement reporting parameters, for example, based on a determination that the reporting condition is satisfied.

The link quality indication may be associated with a radio link measurement. For example, the link quality indication may be an offset value, a scaling value, and/or the link. The link quality indication may be an RSRP, an RSRQ, an RSNI, and/or the like. The link quality indication may be associated with load conditions, for example, the link quality indication may indicate a quality of the link between the second WTRU and the network.

The remote WTRU may be configured to receive configuration information, for example, indicating a measurement reporting condition. The remote WTRU may receive a link quality indication from a relay WTRU. The link quality indication may be associated with a link between the relay WTRU and the network. The remote WTRU may determine a scaled measurement reporting condition. For example, the scaled measurement reporting condition may be determined based on applying a scaling factor to the measurement reporting condition. The scaling factor may be associated with the link quality indication. The scaling factor may be obtained (e.g., received) from the relay WTRU, a neighbor WTRU, or the network. The scaling factor may be determined (e.g., by the remote WTRU), for example, based on the link quality indication. The remote WTRU may be configured to obtain measurement(s) (e.g., perform measurement(s), receive measurement(s)). The measurement(s) may comprise measurement(s) of one or more of the sidelink radio link between the remote WTRU and the relay WTRU, a neighbor sidelink (e.g., a sidelink radio link between the remote WTRU and a second relay WTRU), a neighbor direct link (e.g., a radio link between the remote WTRU and the network via a different gNB), etc. The remote WTRU may be configured to determine if the scaled measurement reporting condition is satisfied, for example, based on the obtained measurement(s). The remote WTRU may be configured to send a measurement report (e.g., the measurement(s)) to the network, for example, based on a determination that the scaled measurement reporting condition is satisfied. The WTRU may be configured to change measurement reporting parameters, for example, based on a determination that the scaled reporting condition is satisfied.

Measurement configuration information may be provided or received. Measurement reporting information may be generated or received. A wireless transmit/receive unit (WTRU) may be configured to modify measurement results (e.g., of a sidelink radio), for example, based on the radio conditions on the backhaul link between the relay WTRU and the gNodeB (gNB). A WTRU may be configured to modify reporting behavior (e.g., for sidelink radio measurements), for example, based on radio conditions on a backhaul link between the relay WTRU and the gNB. A WTRU may be configured to modify measurement results (e.g., of a sidelink radio), for example, based on load conditions at the relay WTRU or the backhaul link between the relay WTRU and the gNB. A WTRU may be configured to modify the reporting behavior (e.g., for sidelink radio measurements), for example, based on load conditions at the relay WTRU or the backhaul link between the relay WTRU and the gNB. A relay WTRU may be configured to provide information to a remote WTRU which may indicate radio/load conditions of a backhaul link between the relay WTRU and the gNB.

In examples, a WTRU may be configured to operate as a remote WTRU for connecting to a base station (e.g., a gNB) via a relay WTRU. The WTRU may receive (e.g., from the network (NW) or the relay WTRU) measurement configuration information related to the sidelink. The WTRU may receive (e.g., from the NW or the relay WTRU) an indication (e.g., link quality indication) about the link between the relay WTRU and the gNB (e.g., referred to as the backhaul link). The indication may include, for example, one or more of the following: the radio conditions between the relay WTRU and the gNB (e.g., radio measurements, such as reference signal received power (RSRP), reference signal received quality (RSRQ), and/or received signal to noise indicator (RSNI), and/or an offset/scaling factor based on the measurements); and/or the load conditions between the relay WTRU and the gNB (e.g., a buffer status at the relay WTRU, or an offset and/or scaling factor based on the buffer status). Measurement configuration information may include trigger conditions and/or events, for example, for reporting serving sidelink and/or neighbor sidelink conditions and/or direct link radio conditions. Trigger conditions may include, for example, one or more of the following: sidelink and/or direct link RSRP, RSRQ, and/or RSNI thresholds; relative offsets between serving sidelink and/or neighbor sidelink and/or direct links; sidelink channel busy ratio (CBR) and/or channel occupation ratio (CR) thresholds; priority of active sidelink radio link control (RLC) channels; uplink (UL) pending data threshold(s); downlink data reception rate and/or volume threshold(s); and/or reporting periodicity. The WTRU may perform the serving/neighbor sidelink and/or direct link measurements. The WTRU may modify the sidelink measurements (e.g., depending on the received indication about the backhaul link), for example, in one or more of the following ways: scaling the sidelink measurement results up and/or down; replacing the sidelink measurements with a weighted average of the sidelink measurements and the received measurements of the backhaul; replacing the sidelink measurements with the weaker of the sidelink measurements and the received backhaul measurements; and/or replacing the sidelink measurements with the stronger of the sidelink measurements and the received backhaul measurements. The WTRU may use the modified sidelink measurements, for example, to determine whether the trigger conditions and/or events for reporting measurements are fulfilled. The WTRU may send the serving and/or neighbor sidelink and/or direct link radio measurements, for example, if/when the trigger conditions are fulfilled.

In examples, trigger conditions (e.g., that depend on indications about the backhaul) may be used in addition to (e.g., on top of) trigger conditions related to the access link (e.g., instead of modifying the access link measurements based on the indications about the backhaul). A WTRU may be configured to operate as a remote WTRU for connecting to a base station (e.g., a gNB) via a relay WTRU. The WTRU may receive (e.g., from the NW or the relay WTRU) measurement configuration information related to the sidelink. The WTRU may receive (e.g., from the NW or the relay WTRU) an indication (e.g., link quality indication) about the link between the relay WTRU and the gNB (e.g., the backhaul link). The indication may include, for example, one or more of the following: the radio conditions between the relay WTRU and the gNB (e.g., radio measurements, such as RSRP, RSRQ, and/or RSNI, and/or an offset/scaling factor based on the measurements); and/or the load conditions between the relay WTRU and the gNB (e.g., a buffer status at the relay WTRU, or an offset and/or scaling factor based on the buffer status). The measurement configuration information may include trigger conditions and/or thresholds related to the radio and load conditions of the backhaul link for reporting serving sidelink and/or neighbor sidelink and/or direct link radio conditions. The measurement configuration information may include trigger conditions and/or thresholds for reporting serving sidelink and/or neighbor sidelink and/or direct link radio conditions related to the radio conditions of the access link. The access link may be, for example, a sidelink between the remote WTRU and the serving relay and/or candidate relay WTRU. The access link may be, for example, a direct link between the remote WTRU and the serving gNB and/or candidate gNB. The WTRU may perform the serving and/or neighbor sidelink and/or direct link measurements. The WTRU may send the measurements results, for example, if/when the trigger conditions for the backhaul and/or the access links are fulfilled.

WTRU to network relays and WTRU to WTRU relays may be used for communications, for example, based on PC5 (e.g., sidelink). NR sidelink (SL) may (e.g., be used to) support automotive/vehicle to everything (V2X) related road safety services. Support may be provided for broadcast, groupcast, and unicast communications for out-of-coverage and/or in-network coverage scenarios. Sidelink-based relaying functionality may support sidelink and/or network coverage extension and/or power efficiency improvement (e.g., for a wide range of applications and services).

Coverage extension for sidelink-based communication may include, for example, WTRU-to-network coverage extension and/or WTRU-to-WTRU coverage extension. In examples of a WTRU-to-network coverage extension, Uu coverage reachability may permit WTRUs to reach a server in a packet data network (PDN) or a counterpart WTRU out of a proximity area. A WTRU-to-network relay may use an evolved universal terrestrial radio access (EUTRA)-based technology (e.g., which may be inapplicable to an NR-based system) for a next generation (NG)-RAN and NR-based sidelink communication. In examples of a WTRU-to-WTRU coverage extension, proximity reachability may support a single-hop sidelink link, e.g., via EUTRA-based or NR-based sidelink technology. Single-hop sidelink coverage may be insufficient, for example, if there is no Uu coverage. Sidelink connectivity may be extended in an NR framework, for example, to support enhanced quality of service (QoS).

Single hop NR sidelink relays may be utilized, for example, for sidelink-based WTRU-to-network and WTRU-to-WTRU relays. One or more of following aspects may be configured (e.g., for a layer-3 relay and/or a layer-2 relay (e.g., RAN2)): relay (re-)selection criterion and procedure; relay and/or remote WTRU authorization; QoS for relaying functionality; service continuity; security of relayed connection; or user plane protocol stack and control plane procedure (e.g., connection management of relayed connection). Operations (e.g., upper layer operations) of a discovery model and/or procedure for sidelink relaying may be supported (e.g., without an additional physical layer channel and/or signal (e.g., RAN2)). In examples, a WTRU-to-network relay and a WTRU-to-WTRU relay may use the same relaying technique. Forward compatibility may be provided for multi-hop relay support. An architecture of an end-to-end packet data convergence protocol (PDCP) and hop-by-hop RLC may support a WTRU-to-network relay (e.g., a layer-2 WTRU-to-network relay).

WTRU to network relays may be supported (e.g., in LTE). Relaying via proximity services (ProSe) WTRU to network relays may extend network coverage to an out of coverage WTRU, for example, by using PC5 (e.g., device to device (D2D) communication) between an out of coverage WTRU and a WTRU-to-Network relay. A ProSe WTRU-to-Network relay may provide an (e.g., a generic) layer 3 (L3) forwarding function that may relay a (e.g., any) type of IP traffic between the remote WTRU and the network. One-to-one and one-to-many sidelink communications may be used between the remote WTRU(s) and the ProSe WTRU-to-Network relay. A (e.g., single) carrier (e.g., Public Safety ProSe Carrier) operation may be supported for a remote WTRU and a relay WTRU (e.g., Uu and PC5 may be the same carrier for a relay and/or remote WTRU). A remote WTRU may be authorized (e.g., by upper layers). A remote WTRU may be in-coverage of a public safety ProSe carrier and/or out-of-coverage on a (e.g., any) supported carriers, which may include a public safety ProSe carrier for WTRU-to-network relay discovery, (re)selection, and/or communication. A ProSe WTRU-to-network relay may (e.g., always) be in-coverage of a EUTRA network (EUTRAN). A ProSe WTRU-to-network relay and a remote WTRU may perform sidelink communication and sidelink discovery.

Relays may be selected for WTRU-to-NW relays. Relay selection and/or reselection for ProSe WTRU-to-NW relays may be performed, for example, based on combination of measurements (e.g., AS layer quality measurements, such as, for example, RSRP) and/or criteria (e.g., upper layer criteria). For example, an eNB may control whether a WTRU can act as a ProSe WTRU-to-Network relay. ProSe WTRU-to-Network relay operation may be supported in a cell, for example, if the eNB broadcasts information associated with ProSe WTRU-to-Network relay operation. An eNB may provide transmission resources for ProSe WTRU-to-Network relay discovery, for example, using broadcast signaling for RRC_IDLE state and dedicated signaling for RRC_CONNECTED state. An eNB may provide reception resources for ProSe WTRU-to-Network relay discovery (e.g., using broadcast signaling). An eNB may broadcast a minimum and/or a maximum Uu link quality (e.g., RSRP) threshold(s) that the ProSe WTRU-to-Network relay may utilize (e.g., before initiating a WTRU-to-Network relay discovery procedure). A WTRU (e.g., in a radio resource control (RRC) idle state (RRC_IDLE) may use the threshold(s) to start or stop (e.g., autonomously start or stop) a WTRU-to-Network relay discovery procedure, for example, if/when the eNB broadcasts transmission resource pools. A WTRU (e.g., in RRC_CONNECTED) may use the threshold(s) to determine, for example, whether the WTRU can indicate to an eNB that the WTRU is a relay WTRU (e.g., a relay WTRU that wants to start ProSe WTRU-to-Network relay discovery). A WTRU may initiate a request for ProSe-WTRU-to-Network relay discovery resources by dedicated signaling (e.g., respecting the broadcasted threshold(s)), for example, if the eNB does not broadcast transmission resource pools for ProSe-WTRU-to-Network relay discovery. A ProSe-WTRU-to-Network relay (e.g., in RRC_IDLE) may perform ProSe WTRU-to-Network relay discovery, for example, if the ProSe-WTRU-to-Network relay is initiated by broadcast signaling. A ProSe WTRU-to-Network relay (e.g., in RRC_CONNECTED) may perform relay discovery, for example, if the ProSe WTRU-to-Network relay is initiated by dedicated signaling.

A ProSe WTRU-to-Network relay may perform sidelink communication for ProSe WTRU-to-Network relay operation, for example, while in RRC_CONNECTED. The ProSe WTRU-to-Network Relay may receive an establishment request (e.g., layer-2 (L2) link establishment request) or a TMGI monitoring request (e.g., upper layer message) from the remote WTRU. The ProSe WTRU-to-Network relay may indicate to the eNB that it is a ProSe WTRU-to-Network relay that may perform ProSe WTRU-to-Network relay sidelink communication. The eNB may provide resources for ProSe WTRU-to-Network relay communication.

A remote WTRU may determine if/when to start monitoring for ProSe WTRU-to-Network relay discovery. A remote WTRU may transmit one or more ProSe WTRU-to-Network relay discovery solicitation messages (e.g., while in RRC_IDLE or in RRC_CONNECTED), for example, depending on the configuration of resources for ProSe WTRU-to-Network relay discovery. An eNB may broadcast a threshold, which may be used by a remote WTRU to determine whether the remote WTRU can transmit ProSe WTRU-to-Network relay discovery solicitation messages, e.g., to connect or communicate with the ProSe WTRU-to-Network relay WTRU. An RRC_CONNECTED remote WTRU may use the broadcasted threshold, for example, to determine whether to indicate to the eNB that it is a remote WTRU that may participate in ProSe WTRU-to-Network relay discovery and/or communication. An eNB may provide transmission resources, for example, using broadcast or dedicated signaling. An eNB may provide reception resources, for example, using broadcast signaling for ProSe WTRU-to-Network relay operation. A remote WTRU may stop using (e.g., refrain from using) ProSe WTRU-to-Network relay discovery and communication resources, for example, if/when the RSRP exceeds a broadcasted threshold.

A time (e.g., exact time) of traffic switching from Uu to PC5 or vice versa may be determined (e.g., by a higher layer). A remote WTRU may perform radio measurements at a PC5 interface. A remote WTRU may use radio measurements for ProSe WTRU-to-Network relay selection and reselection (e.g., along with higher layer criterion). A ProSe WTRU-to-Network relay may be considered suitable (e.g., in terms of radio criteria), for example, if the PC5 link quality exceeds a configured threshold. A threshold may be pre-configured or provided by an eNB. A remote WTRU may select the ProSe WTRU-to-Network relay, for example, if the ProSe WTRU-to-Network relay satisfies higher layer criterion and/or has suitable (e.g., the best) PC5 link quality among (e.g., all) suitable ProSe WTRU-to-Network relays.

The remote WTRU may trigger ProSe WTRU-to-Network relay reselection, for example, if/when the PC5 signal strength of a current ProSe WTRU-to-Network relay is below a configured signal strength threshold; and/or if/when the remote WTRU receives a layer-2 link release message (e.g., an upper layer message is received from the ProSe WTRU-to-Network relay).

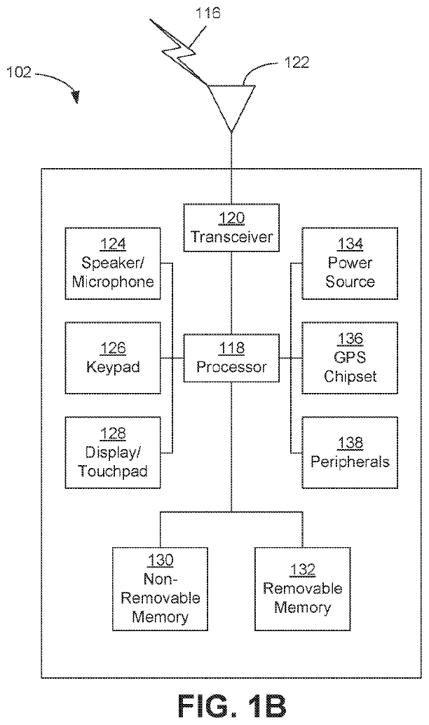

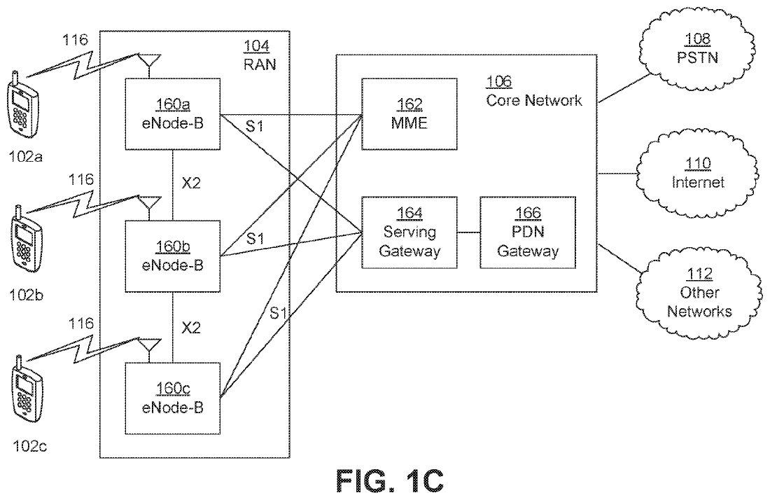

WTRU-to-Network relays may be implemented for wearables. WTRU-to-NW relays may be implemented (e.g., for commercial use), for example, for wearables and IoT devices in a RAN. WTRU-to-NW relays (e.g., for wearables) may use an L2 relay (e.g., as shown by examples of protocol stacks in FIGS. 2 and 3). ProSe WTRU-to-NW relays may use an L3 (e.g., an IP layer) relay.

FIG. 2 illustrates an example of a user plane radio protocol stack for a layer 2 evolved WTRU-to-Network relay (e.g., PC5).

FIG. 3 illustrates an example of a control plane radio protocol stack for a layer 2 evolved WTRU-to-Network relay (e.g., PC5).

Connections may be established for unicast links (e.g., in NR V2X). A relay (e.g., in LTE) may be implemented, for example, based on a one to one communication link (e.g., established at upper layers such as, for example, a ProSe layer) between multiple (e.g., two) WTRUs (e.g., a remote WTRU and a WTRU-to-NW relay). A connection may be transparent (e.g., to the AS layer). Connection management signaling and procedures performed (e.g., at the upper layers) may be carried by data channels (e.g., AS layer data channels). For example, the AS layer may be unaware of a one to one connection.

An access stratum (AS) layer (e.g., in NR V2X) may support the notion of a unicast link between multiple (e.g., two) WTRUs. A unicast link may be initiated by upper layers (e.g., as in a ProSe one-to-one connection). The AS layer may be informed of the presence of a unicast link, e.g., and any data that may be transmitted in unicast fashion between the peer WTRUs. The AS layer (e.g., with knowledge of the unicast link and data transmitted) may support hybrid automatic repeat request (HARQ) feedback, channel quality indicator (CQI) feedback, and/or power control schemes, which may be specific to unicast.

A unicast link at the AS layer may be supported (e.g., via a PC5-RRC connection). A PC5-RRC connection may be a logical connection between a pair of a source layer-2 ID and a destination layer-2 ID in the AS. A (e.g., one) PC5-RRC connection may correspond to a (e.g., one) PC5 unicast link. The PC5-RRC signaling may be initiated, for example, after corresponding PC5 unicast link establishment. The PC5-RRC connection and the corresponding sidelink signaling radio bearers (SRBs) and sidelink data radio bearers (DRBs) may be released, for example, if/when the PC5 unicast link is released (e.g., as indicated by upper layers).

A (e.g., one) sidelink SRB may be used (e.g., for each PC5-RRC connection of unicast) to transmit the PC5-S messages, e.g., before the PC5-S security has been established. A (e.g., one) sidelink SRB may be used to transmit the PC5-S messages to establish the PC5-S security. A (e.g., one) sidelink SRB may be used to transmit the PC5-S messages, for example, after the PC5-S security has been established, which may be protected. A (e.g., one) sidelink SRB may be used to transmit the PC5-RRC signaling, which may be protected and/or sent after the PC5-S security has been established.

PC5-RRC signaling may include a sidelink configuration message (e.g., RRCReconfigurationSidelink). A (e.g., one) WTRU may configure the RX-related parameters of an (e.g., each) sidelink radio bearer (SLRB) in the peer WTRU. A reconfiguration message may configure the parameters of a (e.g., each) protocol in the L2 stack (e.g., service data adaptation layer (SDAP), packet data convergence protocol (PDCP), and/or the like). The receiving WTRU may confirm or reject a configuration, for example, depending on whether it can support the configuration suggested by the peer WTRU.

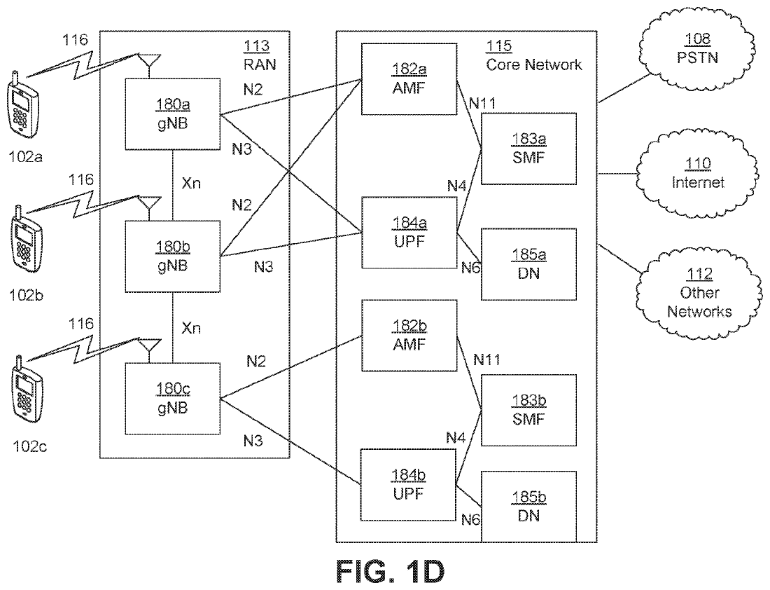

A sidelink relay (e.g., an NR sidelink relay) may be implemented (e.g., as a layer 2 relay). FIGS. 4-7 show examples of protocol stacks for the user plane and control plane of NR L2 WTRU-to-Network relay architecture. An adaptation layer (e.g., for an L2 WTRU-to-Network relay) may be placed over an RLC sublayer for control plane (CP) and user plane (UP) at the Uu interface between a relay WTRU and a gNB. The Uu SDAP/PDCP and RRC may be terminated between a remote WTRU and a gNB, while RLC, MAC and physical layer (PHY) may be terminated in a (e.g., each) link (e.g., the link between a remote WTRU and a WTRU-to-Network relay WTRU and the link between a WTRU-to-Network Relay WTRU and the gNB). An adaptation layer may (or may not) be supported at the PC5 interface between a remote WTRU and a relay WTRU.

FIG. 4 illustrates an example of a user plane stack for an NR L2 WTRU-to-Network relay (e.g., without an adaptation layer at PC5).

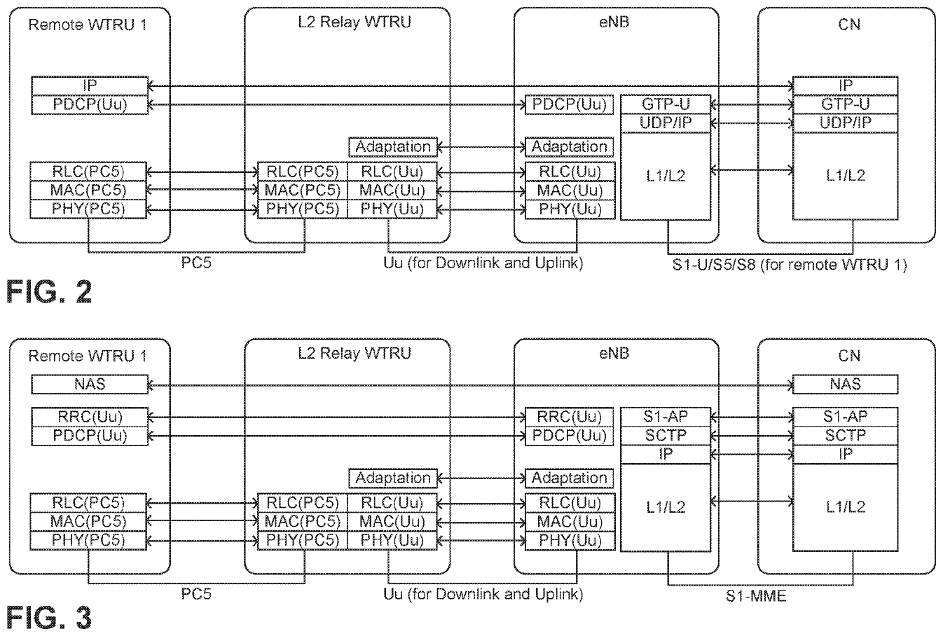

FIG. 5 illustrates an example of a control plane protocol stack for an L2 WTRU-to-Network relay (e.g., without an adaptation layer at PC5).

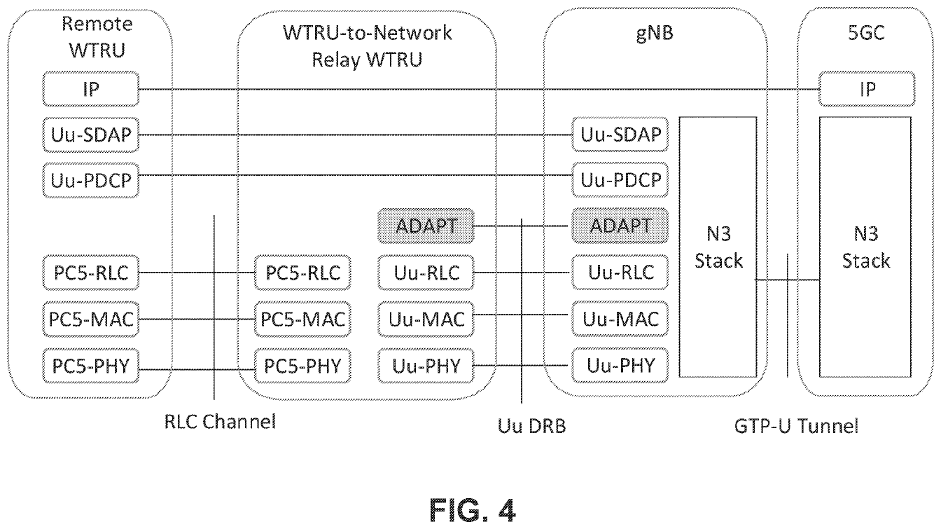

FIG. 6 illustrates an example of a user plane protocol stack for an L2 WTRU-to-Network relay (e.g., with an adaptation layer supported at the PC5 interface).

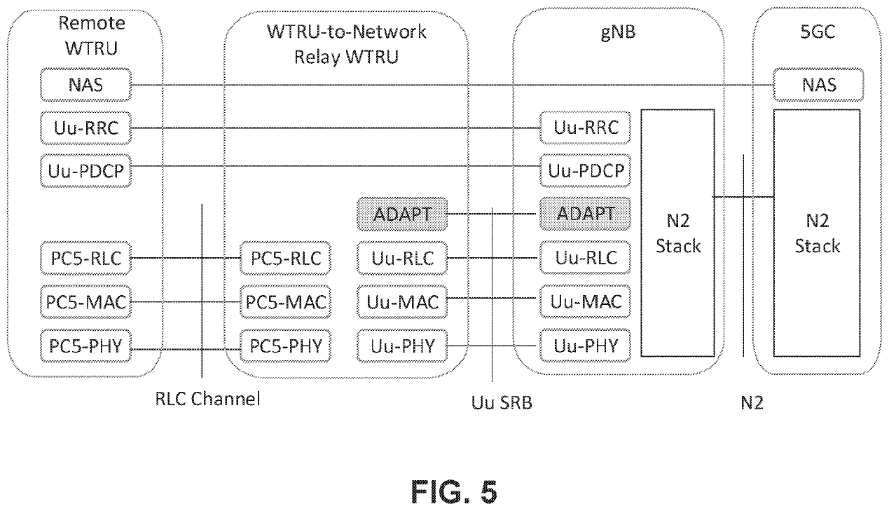

FIG. 7 illustrates an example of a control plane protocol stack for an L2 WTRU-to-Network relay (e.g., with an adaptation layer supported at the PC5 interface).

An example of uplink operation is provided for an L2 WTRU-to-Network Relay. The Uu adaptation layer at a relay WTRU may support UL bearer mapping between ingress PC5 RLC channels for relaying and egress Uu RLC channels over the relay WTRU Uu path. In examples (e.g., for uplink relaying traffic), different end-to-end radio bearers (RBs) (e.g., SRB, DRB) of the same remote WTRU and/or different remote WTRUs may be implemented, for example, with N:1 mapping and/or with data multiplexing over a (e.g., one) Uu RLC channel. The Uu adaptation layer may be used to support remote WTRU identification for the UL traffic (e.g., multiplexing data coming from multiple remote WTRUs). The identity information of a remote WTRU Uu radio bearer and a remote WTRU may be included in the Uu adaptation layer at UL, for example, in order for gNB to correlate the received data packets for the specific PDCP entity associated with the associated or correct remote WTRU Uu radio bearer of a remote WTRU.

An example of downlink operation is provided for an L2 WTRU-to-Network Relay. The Uu adaptation layer may be used to support DL bearer mapping at a gNB, for example, to map end-to-end radio bearers (e.g., SRB, DRB) of a remote WTRU into a Uu RLC channel over a relay WTRU Uu path. The Uu adaptation layer may be used to support DL N:1 bearer mapping and/or data multiplexing between multiple end-to-end radio bearers (e.g., SRBs, DRBs) of a remote WTRU and/or different remote WTRUs and a (e.g., one) Uu RLC channel over the relay WTRU Uu path. The Uu adaptation layer may support remote WTRU identification for downlink traffic. The identity information of a remote WTRU Uu radio bearer and the identity information of a remote WTRU may be put into the Uu adaptation layer, for example, by a gNB at DL, e.g., in order for the relay WTRU to map the received data packets from the remote WTRU Uu radio bearer to an associated PC5 RLC channel.

A gNB implementation may handle the QoS breakdown over Uu and PC5 for the end-to-end QoS enforcement of a particular session established between a remote WTRU and a network, for example, for an L2 WTRU-to-Network relay. Handling may be applied (e.g., configured), for example, if/when PC5 RLC channels with different end-to-end QoS are mapped to the same Uu RLC channel.

Service continuity may be provided. An L2 WTRU-to-Network relay may use a RAN (e.g., RAN2) NR handover procedure (e.g., as a baseline AS layer implementation), for example, to provide (e.g., guarantee) service continuity. A gNB may hand over the remote WTRU to a target cell or target relay WTRU, for example, including one or more of the following: a handover preparation procedure between a gNB and a relay WTRU (e.g., if needed); an RRCReconfiguration to a remote WTRU, e.g., including the remote WTRU switching to the target; and a handover complete message (e.g., similar to a legacy procedure). Content of messages (e.g., handover command) may be provided (e.g., configured). An inter-node message may or may not be sent over Uu.

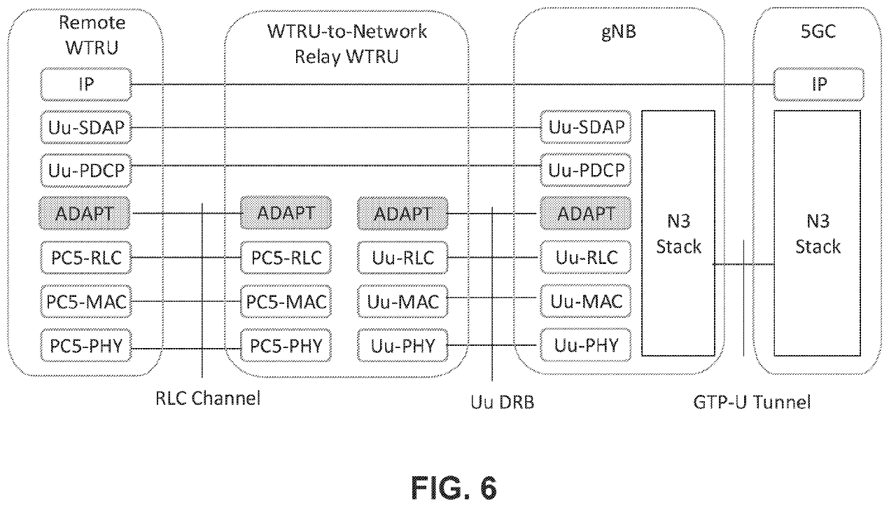

There may be switching from an indirect path to a direct path. FIG. 8 shows an example of a service continuity procedure for an L2 WTRU-to-Network relay (e.g., for a remote WTRU switching to a direct Uu cell).

FIG. 8 illustrates an example procedure for a remote WTRU switching to a direct Uu cell. As shown by example in FIG. 8, at 810, measurement configuration and reporting may be implemented. At 820, a gNB may determine switching to a direct cell. At 830, an RRC reconfiguration message may be sent (e.g., by the gNB) to a remote WTRU. At 840, the remote WTRU may perform random access to the gNB. At 850, the remote WTRU may provide feedback (e.g., an RRCReconfigurationComplete message) to the gNB (e.g., via a target path, using the target configuration provided in the RRC reconfiguration message). At 860, RRC reconfiguration messaging and implementation may occur for the relay WTRU. At 870, a PC5 link may be released between the remote WTRU and the relay WTRU. At 880, data path switching may be implemented. The example procedure does not express or imply any portions of the procedure are required and does not express or imply a required order of the portions of the procedure. For example, the remote WTRU may suspend data transmission, for example, via a relay link (e.g., at or after 830). The portions of the procedure at 860, 870, or 880 may occur in any order. The portion of the procedure at 860 may or may not be implemented and/or may occur before or after the portion of the procedure at 830. The portion of the procedure at 870 may or may not be implemented and/or may occur before the portion of the procedure at 830 or 850. The portion of the procedure at 880 may be implemented after the portion of the procedure at 850.

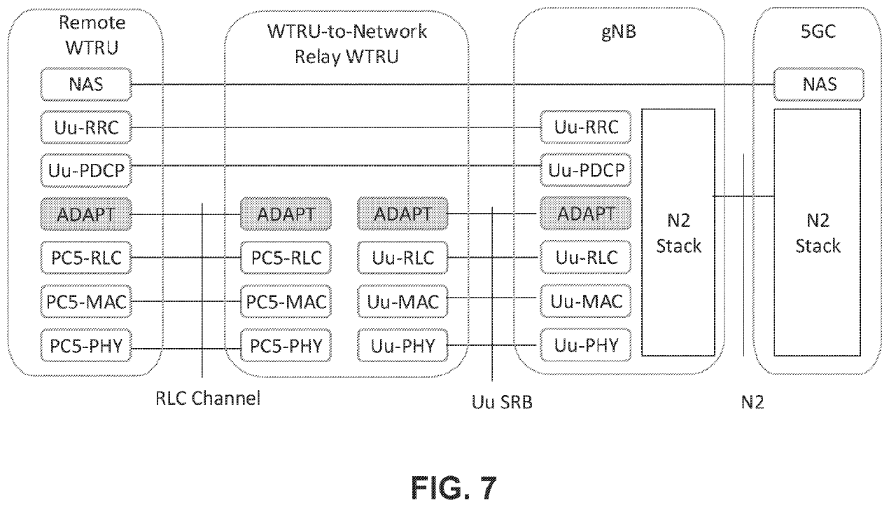

Switching may occur from a direct path to an indirect path. FIG. 9 shows an example of remote WTRU switching to an indirect relay WTRU (e.g., for service continuity of an L2 unmanned aerial vehicle (UAV) to network (U2N) relay).

FIG. 9 illustrates an example procedure for switching a remote WTRU to an indirect relay WTRU. As shown by example in FIG. 9, at 910, a remote WTRU may report one or multiple candidate relay WTRU(s), for example, after the remote WTRU measures and/or discovers one or more candidate relay WTRUs. The remote WTRU may filter the (e.g., appropriate) relay WTRU(s) (e.g., relay WTRU(s) meeting higher layer criteria), for example, when reporting. The reporting may include the relay WTRU's ID and SL RSRP information, and/or information about measurements (e.g., on PC5). At 920, a gNB may determine whether to switch to a target relay WTRU. Target (re)configuration may be sent to a relay WTRU (e.g., in preparation). At 930, an RRC reconfiguration message may be received by a remote WTRU. The message may include, for example, an identity of the target relay WTRU and/or a target Uu and/or PC5 configuration. At 940, the remote WTRU may establish a PC5 connection with the target relay WTRU (e.g., if the connection is not already set up). At 950, the remote WTRU may provide feedback (e.g., an RRCReconfigurationComplete message) to the gNB, for example, via a target path (e.g., using the target configuration provided in RRCReconfiguration). At 960, data path switching may be implemented. The example procedure does not express or imply any portions of the procedure are required and does not express or imply a required order of the portions of the procedure. For example, the portion of the procedure at 920 may be implemented before or after the relay WTRU connects to the gNB (e.g., after 940). In some examples, the portion of the procedure at 940 may be implemented before 920 and/or 930.

Connections may be managed, e.g., by connection management. A remote WTRU may establish PDU sessions and/or DRBs with the network, for example, before user plane data transmission. PC5-RRC aspects of NR V2X PC5 unicast link establishment procedures may be used to set up a secure unicast link between a remote WTRU and a relay WTRU (e.g., for L2 WTRU-to-Network relaying), for example, before the remote WTRU establishes a Uu RRC connection with the network (e.g., via the relay WTRU). A remote WTRU may (e.g., for in-coverage and/or out-of-coverage cases) initiate a first RRC message for connection establishment with a gNB. A PC5 L2 configuration for the transmission between the remote WTRU and the WTRU-to-Network relay WTRU may be based on an RLC/MAC configuration. In some examples, establishment of Uu SRB1/SRB2 and DRB of a remote WTRU may be implemented (e.g., based on legacy Uu configuration procedures for an L2 WTRU-to-Network relay).

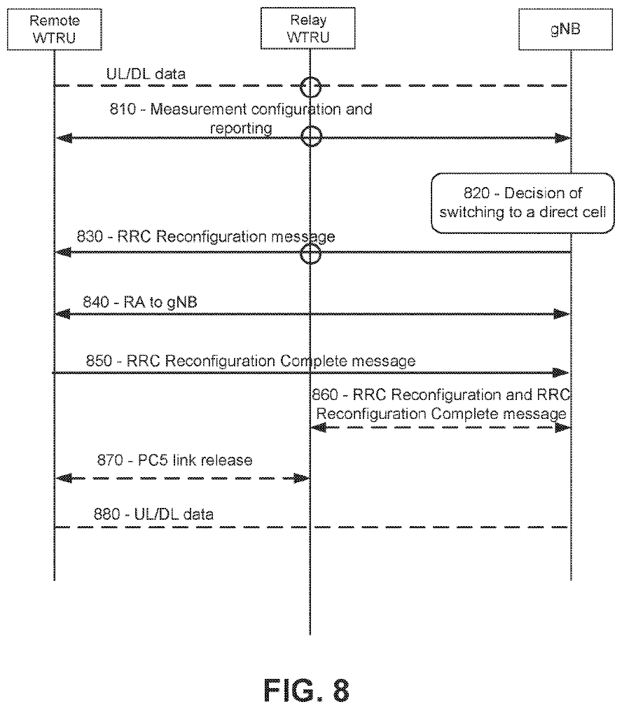

FIG. 10 illustrates an example of a procedure for establishing a remote WTRU connection. FIG. 10 shows a high level connection establishment procedure that may be applicable to an L2 WTRU-to-Network relay. As shown by example in FIG. 10, at 1010, the remote WTRU and relay WTRU may perform a discovery procedure. The remote WTRU and relay WTRU may establish a PC5-RRC connection (e.g., using a legacy procedure).

At 1020, the remote WTRU may send the first RRC message (e.g., RRCSetupRequest) for connection establishment with a gNB via the relay WTRU (e.g., using a default L2 configuration on PC5). The gNB may respond with an RRCSetup message to the remote WTRU. The RRCSetup delivery to the remote WTRU may use the default configuration on PC5. The relay WTRU may perform connection establishment, for example, if the relay WTRU did not start in RRC_CONNECTED. The relay WTRU may forward the RRCSetupRequest/RRCSetup message for the remote WTRU.

At 1030, the gNB and relay WTRU may perform a relaying channel setup procedure (e.g., over Uu). The relay and/or the remote WTRU may (e.g., according to the configuration from the gNB) establish an RLC channel, for example, for relaying of SRB1 towards the remote WTRU over PC5, which may prepare the relaying channel for SRB1.

At 1040, the remote WTRU SRB1 message (e.g., an RRCSetupComplete message) may be sent to the gNB, for example, via the relay WTRU, e.g., using SRB1 relaying channel over PC5. The remote WTRU may be RRC connected over Uu.

At 1050, the remote WTRU and the gNB may establish security (e.g., following a legacy procedure). The security messages may be forwarded through the relay WTRU.

At 1060, the gNB may set up one or more (e.g., additional) RLC channels between the gNB and relay WTRU for traffic relaying. The relay and/or the remote WTRU may (e.g., according to the configuration from the gNB) set up one or more (e.g., additional) RLC channels between the remote WTRU and the relay WTRU for traffic relaying. The gNB may send an RRCReconfiguration to the remote WTRU via the relay WTRU, for example, to set up the relaying SRB2/DRBs. The remote WTRU may (e.g., in response to the RRC reconfiguration) send an RRCReconfigurationComplete to the gNB via the relay WTRU.

A connection establishment procedure (e.g., for an L2 WTRU-to-Network relay), an RRC reconfiguration procedure, and/or an RRC connection release procedure may use, for example, a legacy RRC procedure. A connection establishment procedure (e.g., for an L2 WTRU-to-Network relay), an RRC connection re-establishment, and/or an RRC connection resume procedure may use a legacy RRC procedure, for example, based on the connection establishment procedure of an L2 WTRU-to-Network relay to handle the relay-specific portion of a procedure.

Measurements may be performed (e.g., in NR), for example, on Uu. For example, a WTRU (e.g., in RRC_CONNECTED) may measure one or multiple beams for one or multiple cells. The measurement results (e.g., power values) may be averaged, for example, to derive cell quality. A WTRU may be configured to consider a subset of the detected beams. Filtering may be implemented at one or multiple (e.g., two different) levels, such as at the physical layer (e.g., to derive beam quality) and/or at the RRC level. Filtering may be implemented, for example, to derive cell quality from multiple beams. Cell quality from beam measurements may be derived, for example, in the same or a similar way for the serving cell(s) and for the non-serving cell(s). Measurement reports may include, for example, the measurement results of the X best beams (e.g., based on a configuration of the WTRU by the gNB).

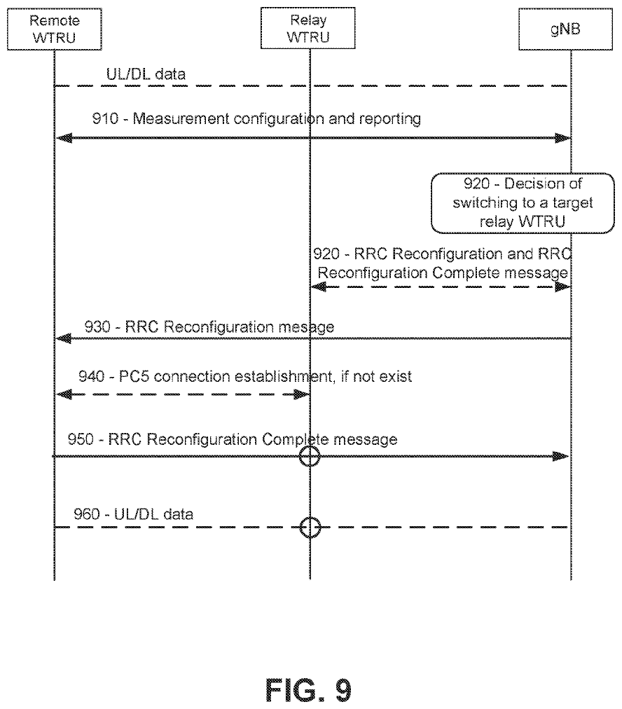

FIG. 11 illustrates an example of a measurement model. FIG. 11 shows an example of a high-level measurement model. K beams may correspond to the measurements on a synchronization signal block (SSB) or channel state information reference signal (CSI-RS) resources configured for L3 mobility by the gNB and detected by WTRU at L1. As shown in FIG. 11, at A, measurements (e.g., beam specific samples) may be internal to the physical layer.

At layer 1 filtering, internal layer 1 filtering may be applied to the inputs measured at point A. Filtering may be implementation dependent. Measurements may be executed in the physical layer.

At A1, measurements (e.g., beam specific measurements) may be reported by layer 1 to layer 3 (e.g., after layer 1 filtering).

At beam consolidation and/or selection, beam specific measurements may be consolidated to derive cell quality. The behavior of the beam consolidation and/or selection may be configured. Configuration information may be provided by RRC signaling. A reporting period at B may be equal to one measurement period at A1.

At B, a measurement (e.g., cell quality) may be derived from beam-specific measurements reported to layer 3 (e.g., after beam consolidation and/or selection).

At layer 3 filtering for cell quality, filtering may be performed on the measurements (e.g., provided at B, as shown in FIG. 11). The behavior of the layer 3 filters may be configured. Configuration information associated with the layer 3 filters may be provided by RRC signaling. A filtering reporting period (e.g., at C) may be equal to one measurement period at B.

At C, a measurement may be provided based on (e.g., after) processing in the layer 3 filter. The reporting rate may be the same (e.g., identical) or similar to the reporting rate at B. The measurement may be used as an input for one or more evaluations of reporting criteria.

At the evaluation of reporting criteria, an evaluation may be performed to determine whether measurement reporting is necessary (e.g., at D, as shown in FIG. 11). The evaluation may be based on one or more flows of measurements at C (e.g., to compare between different measurements). Input C and C1 show an example of multiple flows of measurements. The WTRU may evaluate the reporting criteria for a (e.g., each new) measurement result reported at C and/or C1. The reporting criteria may be configured. Configuration information may be provided by RRC signaling (e.g., WTRU measurements).

At D, measurement report information may be sent (e.g., in a message) on the radio interface.

At L3 beam filtering, filtering may be performed on the measurements (e.g., beam specific measurements) provided at A1. The behavior of beam filters may be configured. Configuration information associated with the beam filters may be provided by RRC signaling. A filtering reporting period at E may be equal to one measurement period at A1.

At E, a measurement (e.g., beam-specific measurement) may be generated (e.g., after processing in the beam filter). The reporting rate may be the same as (e.g., identical to) or similar to the reporting rate at A1. The measurement may be used as an input for selecting measurements (e.g., the X measurements) to be reported.

Beam selection for beam reporting may select X measurements from the measurements provided at point E. The behavior of beam selection may be configured. Configuration information may be provided by RRC signaling.

At F, beam measurement information may be included in a measurement report sent on the radio interface.

Layer 1 filtering may introduce a (e.g., configured) level of measurement averaging. How and when a WTRU performs measurements may be configured (e.g., implementation-specific). Layer 3 filtering for cell quality and related parameters used may be configured (e.g., to avoid introducing delay in the sample availability between B and C). Measurement(s) at C and/or C1 may be the input used in the event evaluation. L3 beam filtering and related parameters used may be configured (e.g., to avoid introducing delay in the sample availability between E and F).

Measurement reports may be configured. Measurement reports may include the measurement identity, for example, of the associated measurement configuration that triggered the reporting. Cell and/or beam measurement quantities for (e.g., to be included in) measurement reports may be configured (e.g., by the network). The number of non-serving cells (e.g., to be reported) may be configured (e.g., by the network). Event evaluation and reporting may refrain from using (e.g., may not use) cells belonging to a blacklist (e.g., configured by the network). Cells belonging to a whitelist (e.g., configured by the network) may be used in event evaluation and reporting. In some examples, only cells belonging to a whitelist may be used in event evaluation and reporting. Beam measurements (e.g., to be included in measurement reports) may be configured (e.g., by the network). Configuration information may include (e.g., indicate), for example, one or more of the following: a beam identifier (e.g., only); a measurement result and a beam identifier; and/or no beam reporting.

Intra-frequency neighbor (e.g., cell) measurements and inter-frequency neighbor (e.g., cell) measurements may be configured. A synchronization signal block (SSB)-based intra-frequency measurement may be generated. A measurement may be (e.g., defined or configured as) an SSB based intra-frequency measurement, for example, if the center frequency of the SSB of the serving cell and the center frequency of the SSB of the neighbor cell are (e.g., approximately) the same and/or if the subcarrier spacing of the SSB of the serving cell and the subcarrier spacing of the SSB of the neighbor cell are (e.g., approximately) the same. An SSB based inter-frequency measurement may be generated. A measurement may be (e.g., defined or configured as) an SSB based inter-frequency measurement, for example, if the center frequency of the SSB of the serving cell and the center frequency of the SSB of the neighbor cell are different and/or the subcarrier spacing of the SSB of the serving cell and the subcarrier spacing of the SSB of the neighbor cell different. In examples of SSB based measurements, a (e.g., one) measurement object may correspond to a (e.g., one) SSB. A WTRU may consider (e.g., treat) different SSBs as different cells.

CSI-RS based intra-frequency measurement may be performed. A measurement may be (e.g., defined as) a CSI-RS based intra-frequency measurement, for example, based on one or more of the following: the subcarrier spacing (SCS) of CSI-RS resources on the neighbor cell configured for measurement is the same as the SCS of CSI-RS resources on the serving cell indicated for measurement; the CP type of CSI-RS resources on the neighbor cell configured for measurement is the same as the CP type of CSI-RS resources on the serving cell indicated for measurement (e.g., for SCS=60 kHz); and/or the center frequency of CSI-RS resources on a neighbor cell configured for measurement is the same as the center frequency of a CSI-RS resource on the serving cell indicated for measurement.

A CSI-RS based inter-frequency measurement may be performed. A measurement may be (e.g., defined or configured as) a CSI-RS based inter-frequency measurement, for example, if the measurement is not a CSI-RS based intra-frequency measurement. An extended CP for CSI-RS based measurement may or may not be supported.

A measurement may be non-gap-assisted or gap-assisted, for example, based on the capability of the WTRU, the active bandwidth part (BWP) of the WTRU, and/or the current operating frequency. In examples (e.g., for SSB based inter-frequency measurement), measurement gap information may be reported by a WTRU. The measurement gap information may indicate a measurement gap configuration. A measurement gap configuration may (e.g., otherwise, always) be provided (e.g., indicated), for example, in one or more of the following cases: the WTRU (e.g., only) supports per-WTRU measurement gaps; the WTRU supports per-frequency range (FR) measurement gaps and/or one or more (e.g., any) of the serving cells are in the same frequency range of the measurement object. In examples (e.g., for SSB based intra-frequency measurement), measurement gap information may be reported by the WTRU. The measurement gap information may indicate a measurement gap configuration. A measurement gap configuration may (e.g., otherwise, always) be provided (e.g., indicated), for example, if/when (e.g., other than an initial BWP) one or more (e.g., any) of the WTRU configured BWPs do not include the frequency domain resources of the SSB associated with the initial DL BWP.

A measurement reporting configuration may be, for example, event triggered or periodical. A WTRU may send a measurement report (e.g., for periodical reporting), for example, every reporting interval. A reporting interval may, for example, range between 120 ms and 30 min.

A WTRU may (e.g., for event triggered measurements) send a measurement report, for example, if/when the conditions associated with the event are fulfilled. A WTRU may continue measuring a serving cell and/or neighbors, may report quantity, and/or may validate based on a threshold or offset defined in a report configuration. In some examples, the report quantity and/or a trigger for an event may be associated with a RSRP, RSRQ, and/or SINR (e.g., a RSRP, RSRQ, and/or SINR threshold).

One or more of the following (e.g., intra-RAT) measurement events may be defined or configured (e.g., for NR): the serving cell measurement becomes better than threshold (e.g., event A1); the serving cell measurement becomes worse than a threshold (e.g., event A2); a neighbor cell measurement becomes better than a special cell (SpCell) measurement by an offset (e.g., event A3); a neighbor cell measurement becomes better than a threshold (e.g., event A4); an SpCell measurement becomes worse than a first threshold (e.g., threshold1) and a neighbor cell measurement becomes better than a second threshold (e.g., threshold2) (e.g., event A5); and/or a neighbor cell measurement becomes better than a secondary cell (SCell) measurement by an offset (e.g., event A6).

Event A1 (e.g., serving cell measurement becomes better than a threshold) may be configured and/or implemented. Event A1 may be used to cancel an ongoing handover procedure. Event A1 may be implemented, for example, if a WTRU moves towards a cell edge and triggers a mobility procedure but moves back into good coverage before the mobility procedure has completed.

Event A2 (e.g., serving cell measurement becomes worse than a threshold) may be configured and/or implemented. Event A2 may not involve any neighbor cell measurements. A2 may be used to trigger a blind mobility procedure. A network may configure the WTRU for neighbor cell measurements, for example, if/when the network receives a measurement report that is triggered due to event A2 (e.g., to save WTRU battery, for example, by not performing neighbor cell measurement when the serving cell quality is good enough).

Event A3 (e.g., a neighbor cell measurement becomes better than an SpCell measurement by an offset) may be configured and/or implemented. Event A3 may be used for a handover procedure. An SpCell may be the primary serving cell of the master cell group (MCG) (e.g., the primary cell (PCell)) or the secondary cell group (SCG) (e.g., the primary SCell (PSCell)). The secondary node (SN) may (e.g., in DC operation) configure an A3 event for an SN triggered PSCell change.

Event A4 (e.g., a neighbor cell measurement becomes better than a threshold) may be configured and/or implemented. Event A4 may be used for handover procedures, for example, that do not depend upon the coverage of the serving cell (e.g., load balancing, where the WTRU may be handed over to a good neighbor cell even when the serving cell conditions are excellent).

Event A5 (e.g., an SpCell measurement becomes worse than threshold) and a neighbor cell measurement becomes better than threshold2) may be configured and/or implemented. Event A5 (e.g., like event A3) may be used for handover. Event A5 (e.g., unlike event A3) may provide a handover triggering mechanism, for example, based on measurements (e.g., absolute measurements) of the serving cell and neighbor cell (e.g., while A3 may use relative comparison). Event A5 may be suitable for time critical handover, such as when the serving cell becomes weak and it becomes necessary to change towards another cell that may not satisfy the criteria for an event A3 handover.

Event A6 (e.g., a neighbor cell measurement becomes better than an SCell measurement by an offset) may be configured and/or implemented. Event A6 may be used for SCell addition/releasing.

One or more of the following (e.g., inter-RAT) measurement events may be defined or configured (e.g., for NR): an inter-RAT neighbor measurement becomes better than a threshold (e.g., event B1); and/or a PCell measurement becomes worse than a first threshold (e.g., threshold)) and an inter-RAT neighbor measurement becomes better than a second threshold (e.g., threshold2).

Event B1 (e.g., an inter-RAT neighbor measurement becomes better than a threshold) may be configured and/or implemented. Event B1 may be equivalent to event A4, but for an inter-RAT handover.

Event B2 (e.g., PCell measurement becomes worse than threshold) and an inter-RAT neighbor measurement becomes better than threshold2) may be configured and/or implemented. Event B2 may be equivalent to event A5, but for an inter-RAT handover.

A WTRU's measurement configuration may include an s-measure configuration (e.g., s-MeasureConfig), which may specify a threshold for an NR SpCell RSRP measurement, for example, to control if/when the WTRU performs measurements on non-serving cells. The value (e.g., of a threshold) may correspond to an SSB-RSRP (e.g., corresponding to a cell RSRP based on an SS/PBCH block) or a choice of a CSI-RSRP (e.g., corresponding to cell RSRP of channel state information reference signal (CSI-RS)). A WTRU may not perform measurements on non-serving cells, for example, if the measured SpCell SSB or CSI RSRP is above the threshold, which may improve WTRU power consumption (e.g., WTRU may refrain from performing (e.g., not perform) unnecessary measurements if the WTRU has sufficient (e.g., good) radio conditions towards the serving cells).

Measurements may be performed on sidelink. Power control may be implemented (e.g., based on one or more measurements). The power spectral density of sidelink transmissions may be adjusted (e.g., for in-coverage operation), for example, based on the pathloss from the gNB. The power spectral density of one or more sidelink transmissions may be adjusted (e.g., for unicast), for example, based on the pathloss between multiple (e.g., two) communicating WTRUs.

A CSI report may be generated (e.g., based on one or more measurements). A CSI-RS may be supported (e.g., for unicast), for example, for CSI measurement and reporting in sidelink. A CSI report may be carried in a sidelink MAC control element (CE).

Physical layer measurements may be defined, configured and/or implemented. One or more of the following WTRU measurement quantities may be supported (e.g., for measurement on the sidelink): physical sidelink broadcast channel (PSBCH) reference signal received power (PSBCH RSRP); physical sidelink shared channel (PSSCH) reference signal received power (PSSCH-RSRP); physical sidelink control channel (PSCCH) reference signal received power (PSCCH-RSRP); sidelink received signal strength indicator (SL RSSI); sidelink channel occupancy ratio (SL CR); and/or sidelink channel busy ratio (SL CBR).

Sidelink measurement configuration and reporting may be implemented. A WTRU may configure an associated peer WTRU to perform (e.g., NR) sidelink measurement(s) and/or report on the corresponding PC5-RRC connection (e.g., in accordance with the NR sidelink measurement configuration for unicast). A WTRU may provide configuration information (e.g., indicating a configuration) in a message (e.g., an RRCReconfigurationSidelink message).

NR sidelink measurement configuration information may indicate (e.g., include), for example, one or more of the following parameters for a PC5-RRC connection: NR sidelink measurement objects; NR sidelink reporting configuration information; NR sidelink measurement identities; and/or NR sidelink quantity configuration information.

NR sidelink measurement objects may include objects on which an associated peer WTRU may perform NR sidelink measurements. For example, an NR sidelink measurement object may indicate the NR sidelink frequency of reference signals to be measured.

NR sidelink reporting configuration information may indicate (e.g., include) one or more NR sidelink measurement reporting configurations. There may be one or multiple NR sidelink reporting configurations per NR sidelink measurement object. A (e.g., each) NR sidelink reporting configuration may include, for example, one or more of the following: a reporting criterion; an RS type; and/or a reporting format. A reporting criterion may include a criterion that may trigger the WTRU to send an NR sidelink measurement report. The criterion may be, for example, periodical or a single event description. An RS type may include an RS that the WTRU may use for NR sidelink measurement results. An RS may include, for example, a demodulation reference signal (DMRS). A reporting format may include one or more quantities that the WTRU may include in a measurement report. In some examples, (e.g., only) an RSRP measurement may be supported.

NR sidelink measurement identities may include, for example, a list of NR sidelink measurement identities. A (e.g., each) NR sidelink measurement identity may link a (e.g., one) NR sidelink measurement object with a (e.g., one) NR sidelink reporting configuration. A configuration (e.g., one configuration) associated with multiple NR sidelink measurement identities may support linking more than one NR sidelink measurement objects to a (e.g., the same) NR sidelink reporting configuration, and/or linking more than one NR sidelink reporting configuration to a (e.g., the same) NR sidelink measurement object. An NR sidelink measurement identity may (e.g., also) be included in an NR sidelink measurement report that triggered the reporting, e.g., serving as a reference to the network.

NR sidelink quantity configuration information may define or configure an NR sidelink measurement filtering configuration that may be used for (e.g., all) event evaluation and related reporting and/or for periodical reporting of an NR sidelink measurement. The same or different filter coefficients may be configured for the same or different NR sidelink measurement quantities, for example, in a (e.g., each) configuration.

WTRUs in a PC5-RRC connection may maintain, for example, an NR sidelink measurement object list, an NR sidelink reporting configuration list, and/or an NR sidelink measurement identities list, e.g., according to signaling and procedures (e.g., as described herein).

A WTRU may derive NR sidelink measurement results, for example, by measuring one or multiple DMRS that may be associated per PC5-RRC connection (e.g., as may be configured by the associated peer WTRU). The WTRU may apply the layer 3 filtering (e.g., for one or more NR sidelink measurement results), for example, before using the measured results for evaluation of reporting criteria and/or measurement reporting. In some examples, (e.g., only) an NR sidelink RSRP may be configured as a trigger quantity and/or a reporting quantity.

One or more of the following measurement events may be defined, configured and/or implemented for an NR sidelink: a first event, such as Event S1 (e.g., serving cell measurement becomes better than a threshold); and/or a second event, such as Event S2 (e.g., serving cell measurement becomes worse than a threshold). A WTRU receiving a S1 and a S2 based measurement (e.g., reports) may use the reports, for example, to adjust the power level if/when transmitting data. Table 1 shows an example of a sidelink measurement report configuration.

TABLE 1
Example of a sidelink measurement report configuration

| | |
|---|---|
| SL-ReportConfigList-r16 ::= | SEQWTRUNCE (SIZE (1..maxNrofSL-ReportConfigId-r16)) OF SL- |
| ReportConfigInfo-r16 | |
| SL-ReportConfigInfo-r16 ::= | SEQWTRUNCE { |
| sl-ReportConfigId-r16 | SL-ReportConfigId-r16, |
| sl-ReportConfig-r16 | SL-ReportConfig-r16, |
| ... | |
| } | |
| SL-ReportConfigId-r16 ::= | INTEGER (1..maxNrofSL-ReportConfigId-r16) |
| SL-ReportConfig-r16 ::= | SEQUENCE { |
| sl-ReportType-r16 | CHOICE { |
| sl-Periodical-r16 | SL-PeriodicalReportConfig-r16, |
| sl-EventTriggered-r16 | SL-EventTriggerConfig-r16, |
| ... | |
| }, | |
| ... | |
| } | |
| SL-PeriodicalReportConfig-r16 ::= | SEQUENCE { |
| sl-ReportInterval-r16 | ReportInterval, |
| sl-ReportAmount-r16 | ENUMERATED {r1, r2, r4, r8, r16, r32, r64, infinity}, |
| sl-ReportQuantity-r16 | SL-MeasReportQuantity-r16, |
| sl-RS-Type-r16 | SL-RS-Type-r16, |
| ... | |
| } | |
| SL-EventTriggerConfig-r16 ::= | SEQUENCE { |
| sl-EventId-r16 | CHOICE { |
| eventS1-r16 | SEQUENCE { |
| s1-Threshold-r16 | SL-MeasTriggerQuantity-r16, |
| sl-ReportOnLeave-r16 | BOOLEAN, |
| sl-Hysteresis-r16 | Hysteresis, |
| sl-Time ToTrigger-r16 | TimeToTrigger, |
| ... | |
| }, | |
| eventS2-r16 | SEQUENCE { |
| s2-Threshold-r16 | SL-MeasTriggerQuantity-r16, |
| sl-ReportOnLeave-r16 | BOOLEAN, |
| sl-Hysteresis-r16 | Hysteresis, |
| sl-TimeToTrigger-r16 | TimeToTrigger |
| ... | |
| }, | |
| ... | |
| }, | |
| sl-ReportInterval-r16 | ReportInterval, |
| sl-ReportAmount-r16 | ENUMERATED {r1, r2, r4, r8, r16, r32, r64, infinity}, |
| sl-ReportQuantity-r16 | SL-MeasReportQuantity-r16, |
| sl-RS-Type-r16 | SL-RS-Type-r16, |
| ... | |
| } | |
| SL-MeasReportQuantity-r16 ::= | CHOICE { |
| sl-RSRP-r16 | RSRP-Range, |
| ... | |
| } | |
| SL-MeasTriggerQuantity-r16 ::= | CHOICE { |
| sl-RSRP-r16 | RSRP-Range, |
| ... | |
| } | |
| SL-RS-Type-r16 ::= | ENUMERATED {dmrs, spare3, spare2, spare1} |
| -- TAG-SL-REPORTCONFIGLIST-STOP | |
| -- ASN1STOP | |

The WTRU variable VarMeasReportListSL may include information about the NR sidelink measurements for which triggering conditions have been met. Table 2 shows an example of the WTRU variable VarMeasReportListSL.

TABLE 2
Example of WTRU variable VarMeasReportListSL

```
-- ASN1START
-- TAG-VARMEASREPORTLISTSL-START
VarMeasReportListSL-r16 ::= SEQUENCE (SIZE
(1..maxNrofSL-MeasId-r16)) OF
VarMeasReportSL-r16
VarMeasReportSL-r16 ::= SEQUENCE {
  -- List of NR sidelink measurement that have been triggered
  sl-MeasId-r16 SL-MeasId-r16,
  sl-FrequencyTriggeredList-r16 SEQUENCE (SIZE
(1..maxNrofFreqSL-r16)) OF ARFCN-ValueNR OPTIONAL,
  sl-NumberOfReportsSent-r16 INTEGER
}
-- TAG-VARMEASREPORTLISTSL-STOP
-- ASN1STOP
```

NR sidelink transmissions may have one or more of the following modes of resource allocations: a first mode, such as Mode 1 (e.g., sidelink resources may be scheduled by a gNB); or a second mode, such as Mode 2 (e.g., a WTRU may autonomously select sidelink resources from one or more (pre-)configured sidelink resource pools, for example, based on a channel sensing mechanism). A WTRU (e.g., an in-coverage WTRU) may be configured to operate in Mode 1 or Mode 2. An out-of-coverage WTRU may operate (e.g., only) in Mode 2.

The QoS of NR sidelink transmissions may be enhanced, for example, by congestion control. Congestion control (e.g., especially in Mode 2) may prevent a transmitting WTRU from occupying a number of resources (e.g., too many resources, such as a number of resources exceeding a threshold) in sidelink transmissions. Congestion control may be implemented, for example, based on one or more (e.g., two) metrics. For example, congestion control may be based on a channel busy ratio (CBR) and/or a channel occupation ratio (CR). A CBR may be (e.g., defined as) the portion of subchannels whose RSSI exceeds a preconfigured value over a certain time duration. A CR (e.g., considering a slot n) may be (e.g., defined as) equivalent to (X+Y)M, where X may be the number of the subchannels that have been occupied by a transmitting WTRU within [n−a, n−1], Y may be the number of the subchannels that have been granted within [n, n+b], and M may be the (e.g., total) number of subchannels within [n−a, n+b].

In examples associated with congestion control, an upper bound of CR, denoted by CRₗᵢₘᵢₜ, may be imposed on a transmitting WTRU, where CRₗᵢₘᵢₜ may be a function of CBR and/or the priority of the sidelink transmissions. In some examples, the amount of resources occupied by a transmitting WTRU may not exceed CRₗᵢₘᵢₜ.

A CBR report may (e.g., also) be used (e.g., by a gNB), for example, to determine the pool of resources allocated to sidelink communication. The pool of resources may be increased, for example, if the WTRUs involved in sidelink communication are reporting high CBRs. The pool of resources may be decreased, for example, if the CBRs reported are low.

Peer WTRUs involved in sidelink operation may configure each other for measurement(s) (e.g., for periodical or S1/S2 events) and/or for in coverage operation (e.g., a remote WTRU may be within the coverage of a gNB). A gNB may configure the remote WTRU with CBR measurements, which may (e.g., also) be periodical and/or event triggered. One or more of the following measurement events may be configured for CBR measurement reporting: a first event, such as Event C1 (e.g., a CBR of NR sidelink communication may become better than an absolute threshold); and/or a second event, such as Event C2 (e.g., a CBR of NR sidelink communication may become worse than an absolute threshold).

Sidelink relay operation may include at least two hops for a remote WTRU's signal (e.g., at least remote WTRU to relay WTRU and relay WTRU to gNB). Multi-hop operations may occur (e.g., in NR). A comparison of (e.g., only) immediate sidelink and a neighbor sidelink/direct links may be insufficient to make (e.g., optimal) handover decisions.

For example, a WTRU may have an excellent sidelink connection with a relay WTRU (e.g., as compared to a candidate direct link), but the relay's connection to the gNB may be experiencing bad radio conditions and/or experiencing congestion, for example, if multiple WTRUs are connected via the relay WTRU. A (e.g., an optimal) decision may be to connect the WTRU to the direct link.

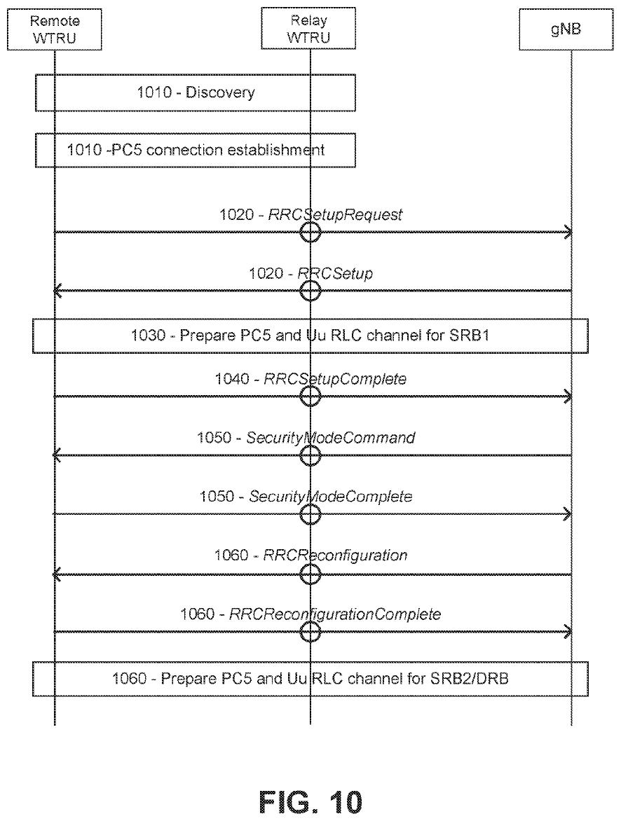

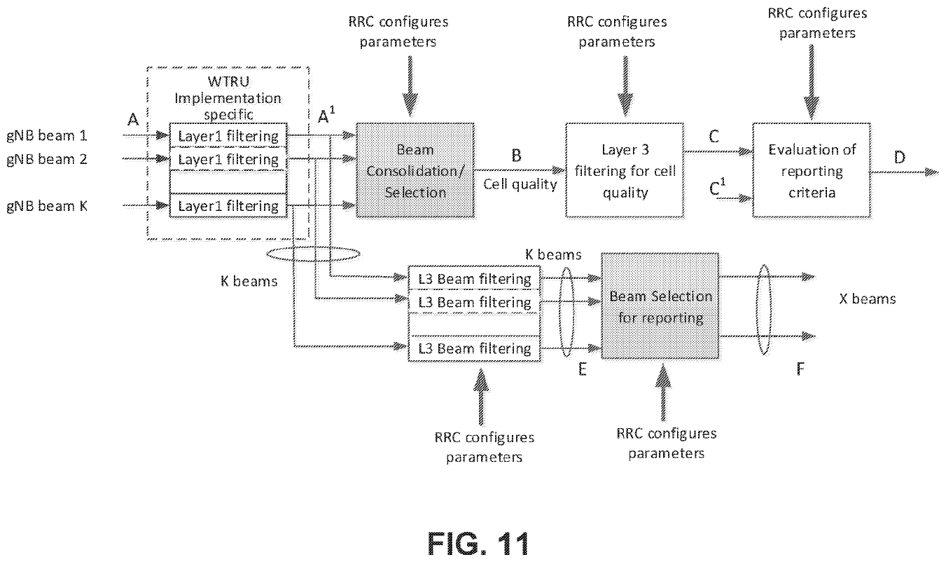

Methods are provided for enhanced measurement performance and/or reporting for sidelink operation. In various examples, a relay WTRU may be used as a WTRU to WTRU relay (e.g., as shown in FIG. 12) or as a WTRU-to-NW relay (e.g., as shown in FIG. 13). The first link may correspond to the link between the source WTRU and the relay WTRU. The second link may refer to the link between the relay WTRU and one or more of the following: the destination and/or the next hop WTRU. A destination may be a WTRU or a network node, for example, depending on whether the relay is a WTRU to WTRU relay or a WTRU-to-NW relay. The next hop WTRU may be a WTRU in a multi-hop WTRU to WTRU or WTRU-to-NW link. In various examples, a source WTRU (e.g., in addition and/or alternative to general usage) may refer to the relay WTRU being served by another relay along the link to a destination.

FIG. 12 illustrates an example of a relay WTRU used as a WTRU to WTRU relay.

FIG. 13 illustrates an example of a relay WTRU used as a WTRU-to-NW relay.

A relay WTRU may be an integrated access and backhaul (IAB) node, which may include multiple (e.g., two) parts. The IAB node may include a distributed unit (DU) of the base station, which may be connected to the remote/source WTRU. The IAB node may include a mobile termination (MT) part (e.g., which may be used to connect to another relay WTRU, e.g., in a multi-hop scenario) or a donor DU of the base station (e.g., in a one hop scenario).

A relay WTRU may be the serving relay WTRU, which may be currently serving the remote WTRU or a neighbor relay WTRU.

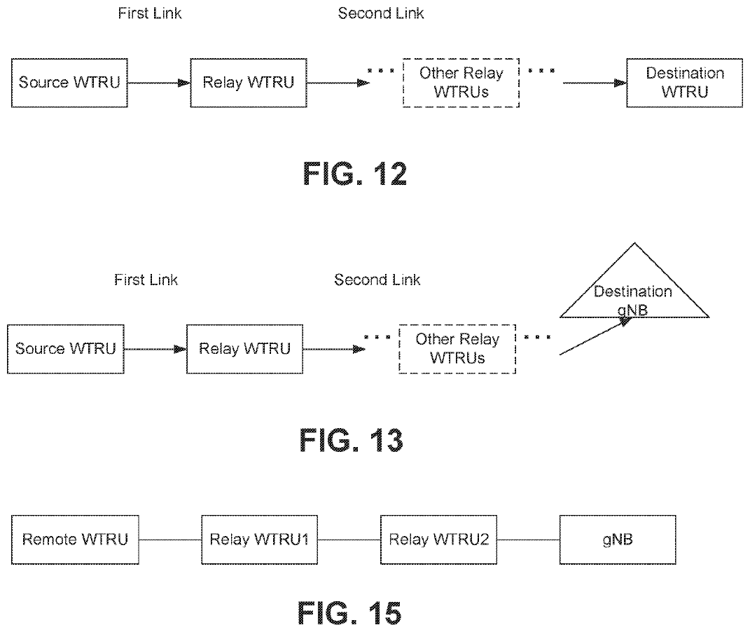

In examples, a WTRU (e.g., a remote WTRU such as the remote WTRU in FIG. 14) may be configured to consider radio conditions (e.g., link quality indication) of the link between the relay WTRU and the gNB (e.g., the backhaul link, such as a Uu backhaul link, as shown in FIG. 14). FIG. 14 illustrates features disclosed herein, including an example of a remote WTRU sending measurement reports based on a backhaul link quality indication.

A remote WTRU may be provided with measurement related information of a link (e.g., Uu link) between a relay WTRU and a gNB (e.g., the remote WTRU may receive a link quality indication from the relay WTRU, for example, indicating the link quality (e.g., backhaul link quality) between the relay WTRU and the gNB, as shown in FIG. 14). The remote WTRU may consider the measurement related information of a Uu link between a relay WTRU and a gNB (e.g., link quality indication, an offset value for an obtained measurement (e.g., on a cell, link, etc.), a radio measurement such as an RSRP, an RSRQ, and/or an RSNI, a load condition associated with the link between the relay WTRU and the gNB, etc.), for example, in addition to the measurement configuration information (e.g., comprising reporting conditions where each reporting condition may be associated with a respective backhaul link quality, which may be a respective backhaul link quality value or a respective range of backhaul link quality values) the remote WTRU received from the gNB and/or the relay WTRU (e.g., as shown in FIG. 14). The remote WTRU may determine to refrain from applying (e.g., not apply) an offset (e.g., or determine to apply a positive offset), for example, if the radio link between the relay WTRU and the gNB is in a good (e.g., excellent) condition (e.g., a measurement associated with the radio link quality exceeding a threshold). An offset (e.g., a negative offset) may be applied, for example, if the radio link between the gNB and the relay WTRU is in a bad condition (e.g., a measurement associated with the radio link quality falls below a threshold).

A relay WTRU may provide an offset and/or scaling value to the remote WTRU, which may be related to the radio condition(s) of the Uu link between the relay WTRU and the gNB (e.g., the backhaul link). The remote WTRU may downgrade and/or upgrade (e.g., scale) the sidelink measurement (e.g., the remote WTRU performed measurement) according to the offset and/or scaling value (e.g., by directly applying the offset or using a value derived from the offset or scaling value), for example, before comparing the value with other radio conditions, e.g., such as neighbor Uu or neighbor sidelink radio conditions. The remote WTRU may downgrade and/or update (e.g., scale) the measurement reporting condition, for example, according to the offset and/or scaling value (e.g., by directly applying the offset or using a value derived from the offset or scaling value) An offset (e.g., one offset) may be used, for example, for one or more (e.g., all) types of measurement quantities (e.g., RSRP, RSRQ, and/or the like), or a different offset may be used for each of multiple types of measurement quantity. In some examples, an offset (e.g., only one offset) may be provided by the relay WTRU. A (e.g., single) offset may be converted to one or multiple values in one or more ways. An offset (e.g., a single offset provided by a relay WTRU) may be converted to different measurement quantities. For example, f1 (offset)=offset_RSRP, f2(offset)=offset_RSRQ, etc.

In some examples, a remote WTRU may modify/change/determine reporting of measurements to the gNB, for example, based on the received indication (e.g., link quality indication) regarding the radio conditions of the link between the relay WTRU and the gNB (e.g., as shown in FIG. 14). A remote WTRU may determine whether to report SL measurement(s) to the gNB, for example, based on the value of the link quality which may be adjusted by the indicated offset (e.g., link quality indication). A remote WTRU may change the reporting periodicity and/or any other parameter related to reporting, for example, based on the indicated offset (e.g., link quality indication). An offset value may be provided, for example, via broadcast (e.g., SIB) and/or in a dedicated manner (e.g., RRC, MAC CE, and/or the like). For example, the offset value may be provided via broadcast, for example, by a relay WTRU, the network, etc.

In some examples, a relay WTRU may provide a measurement (e.g., of the relay WTRU's link towards the gNB) to a remote WTRU (e.g., instead of providing an offset to the remote WTRU). The remote WTRU may upgrade and/or downgrade the measurements of the sidelink, for example, based on the measurement the remote WTRU received from the relay WTRU or a comparison of the sidelink measurement and the measurement the remote WTRU received from the relay WTRU, e.g., before comparing the sidelink measurements with the neighbor measurements. A remote WTRU may not modify sidelink measurements, for example, if the received measurement(s) from the relay WTRU are better (e.g., based on a configured threshold) than the sidelink measurements. The remote WTRU may use the received measurements instead of the sidelink measurements and may compare the received measurements with the neighbor measurements, for example, if the received measurements from the relay WTRU are worse than the sidelink measurements. In some examples, the remote WTRU may use the weaker of the sidelink measurements and the received measurement. In some examples, the remote WTRU may use the strongest of the sidelink measurement and the received measurement. In some examples, the remote WTRU may use the average of the two (e.g. sidelink and received) measurements values. Averaging may be performed in a linear fashion (e.g., (sidelink+received)/2) or may be weighted (e.g., alpha*sidelink+(1−alpha)*received).

A relay WTRU may provide (e.g., to the gNB) a measurement of the link between the relay WTRU and the gNB (e.g., link quality indication). The gNB may determine the offset, e.g., based on the measurement received from the relay WTRU. For example, an offset may be sent (e.g., directly) to the remote WTRU via the relay WTRU (e.g., in an RRC message that is transparently forwarded to the remote WTRU). For example, an offset may be provided to the relay WTRU, and the relay WTRU may communicate the offset to the WTRU (e.g., via SIB broadcast, MAC CE, and/or the like).

The remote WTRU may modify, change, and/or determine parameter(s) associated with reporting of measurements (e.g., to the gNB), for example, based on a received indication (e.g., link quality indication) about the radio conditions of the link between the relay WTRU and the gNB. A remote WTRU may determine whether to report measurements of SL to the gNB, for example, based on the value of the indicated measurement(s) between the relay WTRU and the gNB (e.g., as shown in FIG. 14 and as described herein). For example, the remote WTRU may select a reporting condition from the set of reporting conditions indicated by the measurement configuration information. The reporting condition may be one or more of the following: an RSRP threshold, an RSRQ threshold, a RSNI threshold, and/or the like. The remote WTRU may select the reporting condition (determine an applicable configuration, as shown in FIG. 14), for example, based on the link quality indication (e.g., the indicated measurement(s) between the relay WTRU and the gNB). The remote WTRU may determine if the reporting condition is satisfied, for example, based on the measurement(s) (e.g., of the sidelink radio conditions). The remote WTRU may send the measurement report (e.g., to the network), for example, based on a determination that the reporting condition is satisfied (e.g., report measurement(s) associated with the sidelink and/or a potential direct link according to the selected configuration, e.g., as shown in FIG. 14). A remote WTRU may change the reporting periodicity, and/or any other parameter related to reporting, for example, based on the indicated measurements between the relay and gNB. The remote WTRU may change the reporting periodicity and/or any other parameter related to reporting, for example, based on whether selected reporting conditions are satisfied (e.g., as described herein).

In some examples, a remote WTRU may provide a measurement of the sidelink to a relay WTRU. The relay WTRU may downgrade/upgrade the sidelink measurements received, for example, if/when forwarding the sidelink measurements to the gNB, e.g., depending on the radio conditions between the relay WTRU and the gNB at the time.

In examples, a WTRU may be configured to consider load conditions of the link between the relay WTRU and the gNB.

In some examples, a remote WTRU may be provided with load/congestion related information of a relay WTRU or a Uu link between the relay WTRU and a gNB (e.g., when the relay WTRU is serving as a relay node for multiple WTRUs). The remote WTRU may consider the load/congestion related information, e.g., in addition to the measurement configuration information received from the gNB or/and the relay WTRU.

The relay WTRU may provide an offset and/or scaling value to the remote WTRU. The offset and/or scaling value may be related to a load condition at the relay WTRU. The remote WTRU may downgrade/upgrade (e.g., scale) the sidelink measurement it performed, for example, based on (e.g., according to) the offset and/or scaling value (e.g., by directly applying the offset or by using a value derived from the offset), for example, before comparing the value with a neighbor Uu radio connection. An (e.g., one) offset may be used for one or more (e.g., all) types of measurement quantities (e.g., RSRP, RSRQ, and/or the like), or a different offset may be used for each of multiple types of measurement quantity. A (e.g., single) offset may be converted to one or multiple values in one or more ways. An offset (e.g., a single offset provided by a relay WTRU) may be converted to different measurement quantities. For example, f1 (offset)=offset_RSRP, f2(offset)=offset_RSRQ, etc.

An offset value may be provided via broadcast (e.g., SIB) or in a dedicated manner (e.g., via RRC signaling, MAC CE signaling, and/or the like).

In some examples, a relay WTRU may provide load conditions to the gNB (e.g., in a buffer status report (BSR)). The gNB may determine the load related offset. For example, the offset may be sent (e.g., directly) to the remote WTRU via the relay WTRU (e.g., an RRC message may be transparently forwarded to the remote WTRU). For example, the offset may be provided to the relay WTRU, and the relay WTRU may communicate the offset to the WTRU (e.g., via SIB broadcast, MAC CE signaling, and/or the like).

In some examples, a remote WTRU may provide a measurement of the sidelink to the relay WTRU. The relay WTRU may downgrade and/or upgrade the received sidelink measurements, for example, when forwarding the sidelink measurements to the gNB, e.g., depending on the load conditions at the relay WTRU.

In some examples, a remote WTRU may modify/change and/or determine reporting of measurements to the gNB, for example, based on the load conditions of the link between the relay WTRU and the gNB. A remote WTRU may determine whether to report measurements of an SL to the gNB, for example, based on the value of the indicated load by the relay WTRU. A remote WTRU may change the reporting periodicity, and/or any other parameter related to reporting, for example, based on the load conditions indicated by the relay WTRU.

Load conditions may be related to the load due to one or more (e.g., all) WTRUs being served by the relay WTRU. For example, load conditions may be related to all the WTRUs except the particular remote WTRU towards which the offset is being provided. The load of (e.g., only) other WTRUs may be considered, for example, because if the remote WTRU is handed over to a different relay WTRU or gNB, the same load may be incurred over the link between the different relay WTRU or gNB (e.g., the new link). Thus, in some examples, (e.g., only) the load of the other WTRUs that are congesting the Uu may be considered. The load related offset may be zero (e.g., no load related offset applied), for example, if the WTRU is the (e.g., only) WTRU connected via the relay WTRU.

A load related offset may be communicated via broadcast for different WTRUs. In some examples, different offsets may correspond to the different WTRUs (e.g., offset and corresponding L2 WTRU ID). In some examples, an (e.g., one) offset may capture the load in an average sense. An offset may be based on a load value of L*(n−1)/n, for example, if there are n remote WTRUs, contributing a total load of L.

In examples, a WTRU may be configured to consider load and radio conditions of the link between the relay WTRU and the gNB.

In some examples, a WTRU may be configured with offsets according to the load or radio conditions (e.g., according to methods described herein). The WTRU may apply multiple (e.g., both) offsets independently, e.g., one on top of the other. For example, an offset due to radio conditions may be 1 dB and the offset due to load conditions may be 2 dB. A WTRU may apply an offset of −3 dB on the measured sidelink radio quality and/or quantity, for example, before comparing the value to the neighbor values.

In some examples, a WTRU may apply the minimum of multiple (e.g., two) offsets. For example, an offset due to radio conditions may be 1 dB and the offset due to load conditions may be 2 dB. The WTRU may apply an offset of −1 dB.

In some examples, the WTRU may apply the maximum of multiple (e.g., two) offsets. For example, an offset due to radio conditions may be 1 dB and the offset due to load conditions may be 2 dB. The WTRU may apply an offset of −2 dB.

In some examples, the WTRU may apply the average of multiple (e.g., two) offsets. For example, an offset due to radio conditions may be 1 dB and the offset due to load conditions may be 2 dB. The WTRU may apply an offset of −1.5 dB.

In some examples, a WTRU may apply a weighted value of multiple (e.g., two) offsets. For example, an offset to be applied=radio_bias*radio_offset+load_bias*load_offset, where radio_bias and/or load_bias may be WTRU configurable parameters. Parameters may be static or dynamic.

In some examples, a WTRU may determine how to combine the two offsets (e.g., a WTRU implementation).

In examples, multi-hop considerations may be considered.

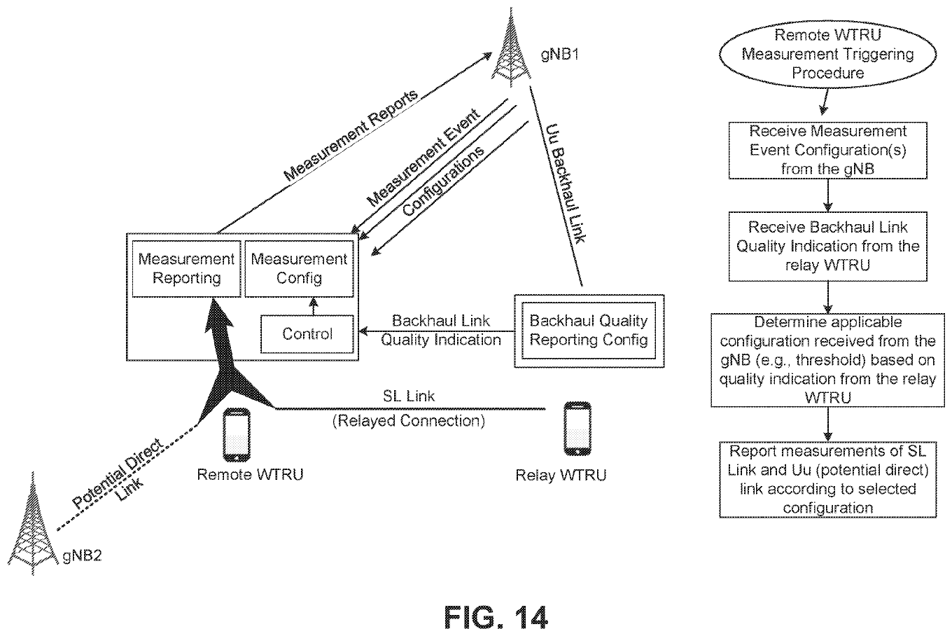

In some examples, a relay WTRU may be (e.g., further) connected to another relay WTRU (e.g., a multi-hop scenario). The relay WTRU may consider the offset and/or scaling provided by the parent node, for example, to determine the scaling and/or offset to provide to a remote WTRU (e.g., or another relay WTRU). For example, consider a scenario illustrated in FIG. 15.

FIG. 15 illustrates an example of multiple relay WTRUs between a remote WTRU and a gNB. As shown in FIG. 15, relay WTRU2 may provide an offset and/or scaling to relay WTRU1. Relay WTRU1 may use the offset and/or scaling information provided in addition to (e.g., on top of) the sidelink radio conditions between relay WTRU1 and relay WTRU2, for example, to determine the offset to provide towards the remote WTRU.

Relay WTRU2 may (e.g., further) indicate whether the offset/scaling to relay WTRU1 has been derived from an additional offset and/or scaling, or may indicate a hop number (e.g., along with the offset scaling or in a separate message). Relay WTRU1 may take into account the information, for example, when determining an offset and/scaling and/or measurements/reporting to the gNB.

In examples, a scaling/offset determination based on Uu information (e.g., how relay WTRU2 determines the offset to provide to relay WTRU1) may be, for example, the same as the determination based on sidelink information (e.g., how relay WTRU1 determines the offset to provide to the remote WTRU). In examples, a scaling/offset determination based on Uu information may be different from the determination based on sidelink information. In some examples, the WTRU may use a (e.g., one) formula to make a first determination (e.g., function 1, which may take Uu radio conditions of the parent hop and produce the offset to provide to the relayed WTRU), and a second formula to make a second determination (e.g., function 2, which may take sidelink radio conditions of the parent hop and produce the offset to provide to the relayed WTRU).

Load based offsets may (e.g., similar to the radio conditions based offsets) be determined at a (e.g., each) relayed WTRU in a multi-hop scenario. Load based offsets may be propagated (e.g., all the way) to the remote WTRU.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1-15. (canceled)

16. A first wireless transmit/receive unit (WTRU) comprising:
a processor configured to:
receive configuration information, wherein the configuration information comprises a set of measurement reporting conditions, and wherein each measurement reporting condition in the set of measurement reporting conditions is associated with a respective backhaul link quality;
receive a link quality indication from a second WTRU, wherein the link quality indication is associated with a link between the second WTRU and a network;
select a measurement reporting condition from the set of measurement reporting conditions based on the link quality indication and the respective backhaul link qualities;
perform a measurement;
determine that the selected measurement reporting condition is satisfied based on the performed measurement; and
send, based on a determination that the measurement reporting condition is satisfied, a measurement report to the network.

17. The first WTRU of claim 16, wherein the respective backhaul link quality is a respective backhaul link quality value or a respective range of backhaul link quality values.

18. The first WTRU of claim 16, wherein the measurement is performed based on measurement information indicated by the configuration information.

19. The first WTRU of claim 16, wherein the selected measurement reporting condition is associated with a reference signal received power (RSRP) threshold, a reference signal received quality (RSRQ) threshold, or a received signal to noise indicator (RSNI) threshold.

20. The first WTRU of claim 16, wherein the link quality indication is associated with a radio measurement, wherein the radio measurement is a reference signal received power (RSRP), a reference signal received quality (RSRQ), or a received signal to noise indicator (RSNI).

21. The first WTRU of claim 16, wherein the link quality indication is associated with a load condition of the link between the second WTRU and the network.

22. The first WTRU of claim 16, wherein the performed measurement is associated with a neighbor link and a link between the first WTRU and the second WTRU, and wherein the neighbor link is a link between the first WTRU and a third WTRU or a link between the first WTRU and the network.

23. A method for a first wireless transmit/receive unit (WTRU) comprising:
receiving configuration information, wherein the configuration information comprises a set of measurement reporting conditions, and wherein each measurement reporting condition in the set of measurement reporting conditions is associated with a respective backhaul link quality;
receiving a link quality indication from a second WTRU, wherein the link quality indication is associated with a link between the second WTRU and a network;
selecting a measurement reporting condition from the set of measurement reporting conditions based on the link quality indication and the respective backhaul link qualities;
performing a measurement;
determining that the selected measurement reporting condition is satisfied based on the performed measurement; and
sending, based on a determination that the measurement reporting condition is satisfied, a measurement report to the network.

24. The method of claim 23, wherein the respective backhaul link quality is a respective backhaul link quality value or a respective range of backhaul link quality values.

25. The method of claim 23, wherein the measurement is performed based on measurement information indicated by the configuration information, and wherein the link quality indication is associated with a load condition of the link between the second WTRU and the network.

26. The method of claim 23, wherein the selected measurement reporting condition is associated with a reference signal received power (RSRP) threshold, a reference signal received quality (RSRQ) threshold, or a received signal to noise indicator (RSNI) threshold, wherein the link quality indication is associated with a radio measurement, and wherein the radio measurement is an RSRP, an RSRQ, or an RSNI.

27. The method of claim 23, wherein the performed measurement is associated with a neighbor link and a link between the first WTRU and the second WTRU, and wherein the neighbor link is a link between the first WTRU and a third WTRU or a link between the first WTRU and the network.

28. A first wireless transmit/receive unit (WTRU) comprising:
a processor configured to:
receive configuration information, wherein the configuration information indicates a measurement reporting condition;
receive a link quality indication from a second WTRU, wherein the link quality indication is associated with a link between the second WTRU and a network;
determine a scaled measurement reporting condition, wherein the scaled measurement reporting condition is determined based on applying a scaling factor to the measurement reporting condition, and wherein the scaling factor is associated with the link quality indication;
perform a measurement;
determine that the scaled measurement reporting condition is satisfied based on the performed measurement; and
send, based on a determination that the scaled measurement reporting condition is satisfied, a measurement report to the network.

29. The first WTRU of claim 28, wherein the scaling factor is received from the second WTRU or the network.

30. The first WTRU of claim 29, wherein the processor is further configured to determine the scaling factor based on the link quality indication.
